(19) United States
(12) Patent Application Publication
(10) Pub. No.: US 2016/0363769 A1
(43) Pub. Date: Dec. 15, 2016

(54) LIGHT GUIDE AND HEAD MOUNTED DISPLAY

(71) Applicant: SHARP KABUSHIKI KAISHA, Osaka-shi, Osaka (JP)

(72) Inventors: Takeshi MASUDA, Osaka-shi (JP); Atsuyuki TANAKA, Osaka-shi (JP)

(21) Appl. No.: 15/038,748

(22) PCT Filed: Nov. 20, 2014
(86) PCT No.: PCT/JP2014/080770

§ 371 Date: May 24, 2016

(30) Foreign Application Priority Data
Nov. 25, 2013 (JP) 2013-243108

(51) Int. Cl. G02B 27/01; F21V 8/00

(52) U.S. Cl. CPC G02B 27/0172; G02B 6/0028; G02B 6/003; G02B 6/0055; G02B 2027/0118; G02B 2027/0125

(57) ABSTRACT

A lightguide (100a) includes a first light guiding member (1A) having a first light-receiving surface (12A) to receive a collimated light beam, a first lightguide section (20A) to allow the light beam entering at the first light-receiving surface (12A) to propagate in a first direction, and a first outgoing face (29A) through which the light beam propagating in the first lightguide section (20A) is allowed to exit in a second direction intersecting the first direction; and a second light guiding member (30A) having a second light-receiving surface (31A) to receive the light beam exiting from the first outgoing face (29A), a second lightguide section (30A) to allow the light beam entering at the second light-receiving surface (31A) to propagate in the second direction, and a second outgoing face (39A) through which the light beam propagating in the second lightguide section (30A) is allowed to exit in a third direction intersecting the first and second directions.

### TECHNICAL FIELD

The present invention relates to a lightguide and a head-mounted display. A lightguide according to the present invention is suitably used for a head-mounted display.

### BACKGROUND ART

Patent Document 1 discloses a light beam expander which is suitable for a head-mounted display. The light beam expander which is shown in FIG. 16 of Patent Document 1 includes a light guiding plate (i.e., a substrate through which light is transmitted) which receives a collimated displaying light beam. On the light guiding plate, a reflecting surface and a plurality of first partially reflecting surfaces and a plurality of second partially reflecting surfaces are provided.

A light beam which is incident on a light guiding plate is reflected in a first direction by the reflecting surface, and propagates within the light guiding plate along the first direction. The plurality of first partially reflecting surfaces adjoin one another, in parallel, along the first direction. Portions of the light beam propagating along the first direction are reflected by the plurality of first partially reflecting surfaces in a second direction which is orthogonal to the first direction. Over the course of this, the light beam is expanded in the first direction. The plurality of second partially reflecting surfaces adjoin one another, in parallel, along the second direction. Portions of the light beam propagating along the second direction are reflected by the plurality of second partially reflecting surfaces in a third direction which is orthogonal to the first and second directions. Over the course of this, the light beam is expanded in the second direction. The light beam which is reflected off the plurality of second partially reflecting surfaces exits the light guiding plate. The light beam exiting the light guiding plate has been expanded in the first and second directions, thus allowing the eye to be situated in a broad range of positions to view a virtual image.

### CITATION LIST

### Patent Literature

[Patent Document 1] Japanese National Phase PCT Laid-Open Publication No. 2003-536102 (USP No. 6829095)

### SUMMARY OF INVENTION

### Technical Problem

However, a study by the inventors has found that the light beam expander described in Patent Document 1 has a problem in that the brightness of the virtual image to be viewed is lower in peripheral portions than in the central portion.

The size (viewing angle) of a virtual image to be viewed by using the light beam expander described in Patent Document 1 is determined by the angle range in which a collimated displaying light beam enters the eye of a viewer through the light beam expander. For example, a displaying light beam having exited the display panel is collimated in a different direction depending on the position (i.e., the pixel position) at which the light beam made the exit. In other words, the direction in which a light beam that exits a peripheral pixel of the display panel is collimated constitutes a predetermined angle with the direction in which a light beam that exits a pixel in the center of the display panel is collimated. This angle difference determines the viewing angle (i.e., the angle of view of the virtual image).

A light beam exiting a pixel in the center of the display panel strikes the plurality of first partially reflecting surfaces and the plurality of second partially reflecting surfaces in the center. On the other hand, a light beam exiting a peripheral pixel of the display panel strikes the plurality of first partially reflecting surfaces and the plurality of second partially reflecting surfaces in the center; however, while some of the light beam exiting a peripheral pixel of the display panel strikes the plurality of first partially reflecting surfaces and the plurality of second partially reflecting surfaces in a peripheral portion thereof, the rest fails to be incident on the plurality of first partially reflecting surfaces or the plurality of second partially reflecting surfaces. This is the cause of the problem where the brightness of the virtual image to be viewed is lower in peripheral portions than in the central portion.

As a method for suppressing this, it might be possible to reduce the diameter of the collimated displaying light beam, or conversely, enlarge the first and second partially reflecting surfaces. However, reducing the diameter of the displaying light beam has a disadvantage in that the efficiency of light utility will be lowered; on the other hand, enlarging first and second partially reflecting surfaces has a disadvantage in that the light beam expander will increase in size. Although it might be possible to reduce the angle difference between directions of collimated displaying light beams, this will create a disadvantage in that the viewing angle (i.e., the angle of view of the virtual image) is decreased.

A main objective of the present invention is to provide a lightguide which is able to reduce unevenness in the brightness of a virtual image to be viewed, while restraining the aforementioned disadvantages. Another objective of the present invention is to provide a head-mounted display including such a lightguide.

### Solution to Problem

A lightguide according to an embodiment of the present invention comprises: a first light guiding member having a first light-receiving surface to receive a collimated light beam, a first lightguide section to allow the light beam entering at the first light-receiving surface to propagate in a first direction, and a first outgoing face through which the light beam propagating in the first lightguide section is allowed to exit in a second direction intersecting the first direction; and a second light guiding member having a second light-receiving surface to receive the light beam exiting from the first outgoing face, a second lightguide section to allow the light beam entering at the second light-receiving surface to propagate in the second direction, and a second outgoing face through which the light beam propagating in the second lightguide section is allowed to exit in a third direction intersecting the first and second directions.

In one embodiment, the first light guiding member includes a coupling section having the first light-receiving surface; and the first light-receiving surface is inclined at predetermined angles with respect to the first, second and third directions.

In one embodiment, the first light guiding member has a plurality of first slopes inclined in the first direction; and the plurality of first slopes allow the light beam propagating in the first lightguide section to be reflected in the second direction, and expands the light beam in the first direction.

In one embodiment, the second light guiding member has a plurality of second slopes inclined in the second direction; and the plurality of second slopes allow the light beam propagating in the second lightguide section to be reflected in the third direction, and expands the light beam in the second direction.

In one embodiment, the plurality of first slopes constitute an angle α₁ with a plane P₁₃ containing the first and third directions, and the plurality of second slopes constitute an angle α₂ with a plane P₁₂ containing the first and second directions, the angle α₁ and the angle α₂ each independently being 45° or less.

In one embodiment, the first light-receiving surface constitutes, in the plane P₁₂, an angle of 2·α₁ with the plane P₂₃, and in a plane P′₂₃ resulting from rotating the plane P₂₃ by (90−2·α₁) degrees around the third direction, an angle of 2·α₂ with the plane P₁₂. It is preferable that α₁ is not less than 1 and not more than 30, for example.

In one embodiment, the first light-receiving surface has a side whose length is equal to or greater than twice the length along the second direction of a cross section of the first lightguide section which is parallel to the plane P₂₃, and a side whose length is equal to or greater than twice the length along the third direction of a cross section of the first lightguide section which is parallel to the plane P₁₃.

In one embodiment, the first lightguide section includes a rod portion which is elongated in the first direction, and the second lightguide section includes a planar portion which is parallel to a plane containing the first and second directions.

One embodiment comprises one said first light guiding member and two said second light guiding members arrayed in parallel along the first direction.

A head-mounted display according to an embodiment of the present invention comprises: a display panel; a collimating optical system to collimate displaying light exiting the display panel and emit a collimated light beam; and any of the above lightguides, the lightguide being disposed so that the first light-receiving surface receives the light beam having been collimated through the collimating optical system.

### Advantageous Effects of Invention

According to an embodiment of the present invention, there is provided a lightguide which is able to reduce unevenness in the brightness of a virtual image to be viewed. According to an embodiment of the present invention, there is provided a head-mounted display including such a lightguide.

### BRIEF DESCRIPTION OF DRAWINGS

FIG. 1 (a) is a schematic perspective view of a head-mounted display 100A according to an embodiment of the present invention; and (b) is a schematic enlarged view of a prism region 32A of a second light guiding member (second lightguide section) 30A of a lightguide 100a.

FIGS. 2 (a) to (c) are schematic diagrams showing the structure of the lightguide 100a and optical paths of light beams as viewed in a direction which is perpendicular to the XY plane, where (a) illustrates optical paths of light beams (broken lines) exiting pixels in the center of the displaying region of a display panel 50; (b) illustrates optical paths of light beams (dot-dash lines) exiting pixels at the lower edge of the displaying region; and (c) illustrates optical paths of light beams (solid lines) exiting pixels at the upper edge of the displaying region.

FIG. 3 (a) to (c) are schematic diagrams showing the structure of the lightguide 100a and optical paths of light beams as viewed in a direction which is perpendicular to the XZ plane, where (a) illustrates optical paths (broken lines) of light beams exiting pixels in the center of the displaying region of the display panel 50; (b) illustrates optical paths (dot-dash lines) of light beams exiting pixels at the right edge of the displaying region; and (c) illustrates optical paths (solid lines) of light beams exiting pixels at the left edge of the displaying region.

FIG. 4 (a) is a schematic diagram showing the structure of a first light guiding member 1A and optical paths of light beams as viewed in a direction which is perpendicular to the XY plane; and (b) is a schematic diagram showing optical paths of light beams in a prism region 22A of the first lightguide section 20A.

FIG. 5 (a) is a schematic diagram showing the structure of the lightguide 100a and incident angles of light beams as viewed in a direction which is perpendicular to the XY plane; (b) is a schematic diagram showing the structure of the lightguide 100a as viewed in a direction perpendicular to the XZ plane; and (c) is a schematic diagram showing optical paths of light beams in the first lightguide section 20A and the second lightguide section 30A.

FIGS. 6 (a) and (b) are schematic diagrams for describing an exemplary method of producing a second light guiding member 30A, a reflective layer 36a having openings, and a transparent resin layer 38.

FIG. 7 (a) is a diagram showing optical paths of light beams (central direction) propagating in the first lightguide section 20A in the case where there is no coupling section 10A; (b) is a diagram showing optical paths of light beams (central direction and top-bottom direction) entering the coupling section 10A; and (c) is a diagram describing the shape of the coupling section 10A.

FIG. 8 (a) is a schematic perspective view of an HMD 100B according to an embodiment of the present invention; and (b) is a schematic enlarged view of a prism region 32A of a second light guiding member (second lightguide section) 30B of a lightguide 100b.

FIG. 9 (a) to (c) are schematic diagrams showing the structure of the lightguide 100b and optical paths of light beams as viewed in a direction which is perpendicular to the XY plane, where (a) illustrates optical paths of light beams (broken lines) exiting pixels in the center of the displaying region of a display panel 50; (b) illustrates optical paths of light beams (dot-dash lines) exiting pixels at the right edge of the displaying region; and (c) illustrates optical paths of light beams (solid lines) exiting pixels at the left edge of the displaying region.

FIG. 10 (a) is a schematic diagram showing the structure of a coupling section 10B and optical paths of light beams as viewed in a direction which is perpendicular to the XZ plane; and (b) is a schematic diagram showing the structure of the lightguide 100a and optical paths of light beams as viewed in a direction which is perpendicular to the YZ plane, illustrating optical paths (broken lines) of light beams exiting pixels in the center of the displaying region of the display panel 50.

FIG. 11 (a) is a schematic diagram showing the structure of a coupling section 10B and optical paths of light beams as viewed in a direction which is perpendicular to the XZ plane; and (b) is a schematic diagram showing the structure of the lightguide 100b and optical paths of light beams as viewed in a direction which is perpendicular to the YZ plane, illustrating optical paths of light beams (dot-dash lines) exiting pixels at the lower edge of the displaying region of the display panel 50.

FIG. 12 (a) is a schematic diagram showing the structure of a coupling section 10B and optical paths of light beams as viewed in a direction which is perpendicular to the XZ plane; (b) is a schematic diagram showing the structure of the lightguide 100b and optical paths of light beams as viewed in a direction which is perpendicular to the YZ plane, illustrating optical paths of light beams (solid lines) exiting pixels at the upper edge of the displaying region of the display panel 50.

FIG. 13 (a) is a schematic diagram showing the structure of a first light guiding member 1B and optical paths of light beams as viewed in a direction which is perpendicular to the XY plane; and (b) is a schematic diagram showing optical paths of light beams in a prism region 22B of a first lightguide section 20B.

FIG. 14 A schematic diagram showing the structure of the lightguide 100b and optical paths of light beams as viewed in a direction which is perpendicular to the XY plane.

FIG. 15 (a) is a schematic diagram showing the structure of the lightguide 100b as viewed in a direction which is perpendicular to the YZ plane; and (b) is a schematic diagram showing optical paths of light beams in the first lightguide section 20B and the second lightguide section 30B.

FIG. 16 (a) is a diagram showing optical paths of light beams (central direction and right-left direction) entering the coupling section 10B; and (b) is a diagram describing the shape of the coupling section 10B.

FIGS. 17 (a) and (b) are diagrams for describing aberration associated with the collimating optical system 60, where (a) shows aberration along the right-left direction; (b) shows aberration along the top-bottom direction; and (c) is a diagram showing how a virtual image 50′ may be blurred.

FIGS. 18 (a) and (b) are diagrams showing relative positioning of the display panel 50 and the collimating optical system 60 and a first light-receiving surface 12A or 12B.

FIG. 19 A schematic perspective view of an HMD 100C according to another embodiment of the present invention.

### DESCRIPTION OF EMBODIMENTS

Hereinafter, with reference to the drawings, lightguides and head-mounted displays (hereinafter referred to as “HMDs”) according to embodiments of the present invention will be described. Although lightguides for HMDs will be described herein, lightguides according to embodiments of the present invention are not limited thereto, but may be head-up displays (which may also be referred to as “HUDs”) or other virtual image display or the like.

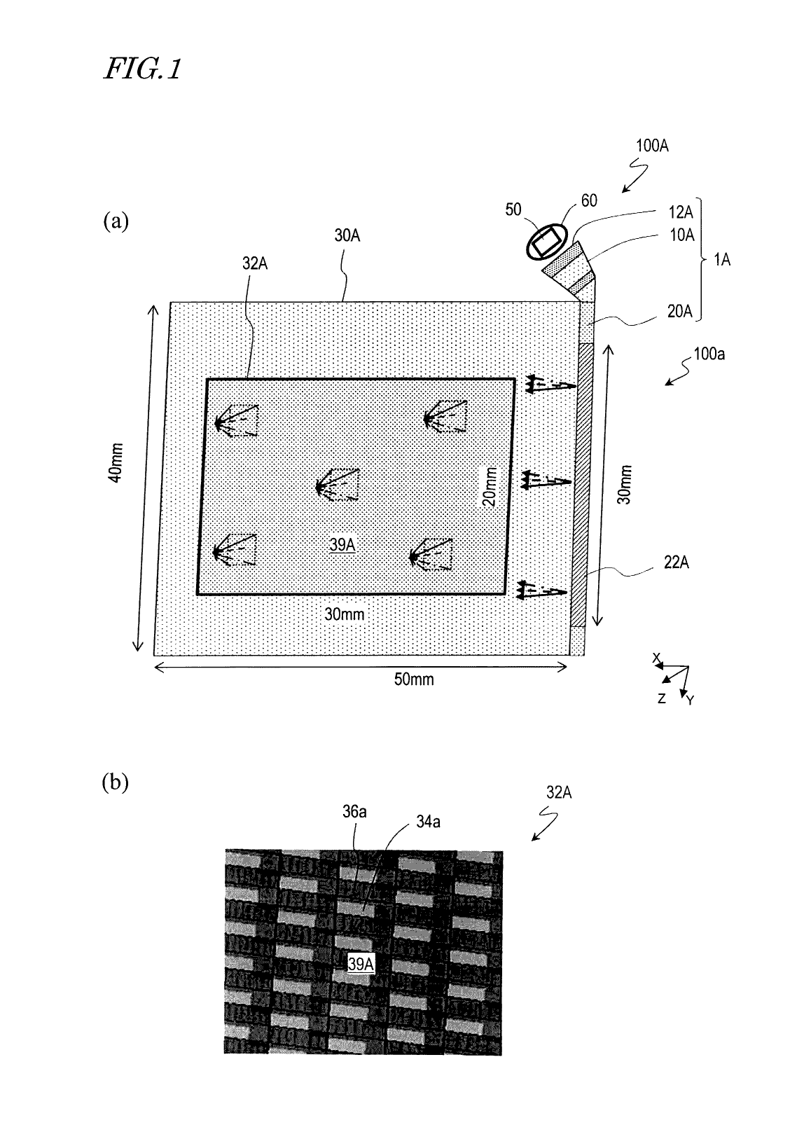

With reference to FIG. 1 to FIG. 7, the structure and function of a head-mounted display 100A according to an embodiment of the present invention will be described.

FIG. 1(a) shows a schematic perspective view of a head-mounted display 100A according to an embodiment of the present invention. The HMD 100A includes a lightguide 100a according to an embodiment of the present invention. FIG. 1(b) shows a schematic enlarged view of a prism region 32A of a second light guiding member (second lightguide section) 30A of the lightguide 100a.

As shown in FIG. 1(a), the HMD 100A includes the lightguide 100a, a display panel 50, and a collimating optical system 60 which collimates displaying light exiting the display panel 50 and emits a collimated light beam. The lightguide 100a is disposed so as to receive the light beam having been collimated through the collimating optical system 60 on a predetermined surface.

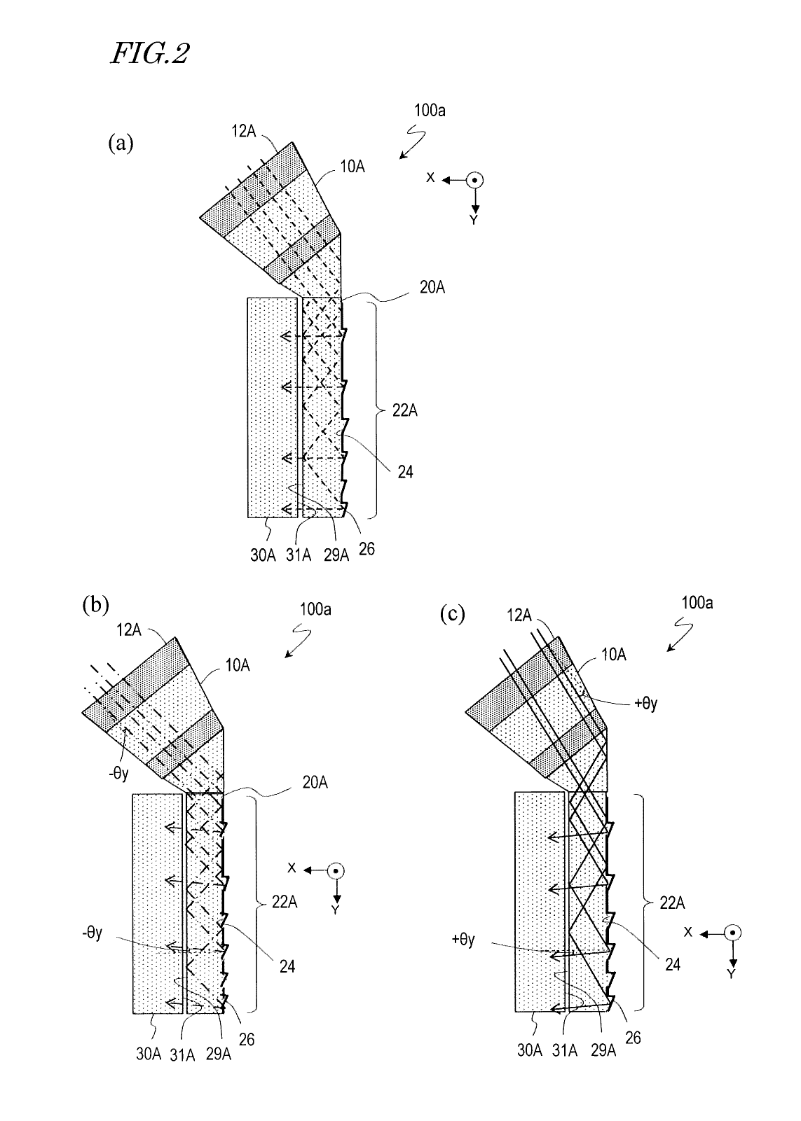

The lightguide 100a includes: a first light guiding member 1A having a first light-receiving surface 12A to receive a collimated light beam, a first lightguide section 20A to allow a light beam entering at the first light-receiving surface 12A to propagate in a first direction (the Y direction), and a first outgoing face 29A through which a light beam propagating in the first lightguide section 20A is allowed to exit in a second direction (the X direction) intersecting the first direction; and a second light guiding member 30A having a second light-receiving surface 31A to receive a light beam exiting from the first outgoing face 29A, a second lightguide section 30A to allow a light beam entering at the second light-receiving surface 31A to propagate in the second direction (the X direction), and a second outgoing face 39A through which a light beam propagating in the second lightguide section 30A is allowed to exit in a third direction (the Z direction) intersecting the first and second directions. Note that the second lightguide section and the second light guiding member are denoted by the same reference numeral 30A. For the first outgoing face 29A and the second light-receiving surface 31A, see FIGS. 2(a) to (c); for the second outgoing face 39A, see FIG. 1(b).

The lightguide 100a, which includes the first light guiding member 1A and the second light guiding member 30A, is able to reduce unevenness in the brightness of a virtual image to be viewed. A light beam which enters the first lightguide section 20A and the second lightguide section 30A strikes each outgoing face at an angle which is equal to or greater than the critical angle, and through repetitive total reflection, propagates in the first lightguide section 20A and the second lightguide section 30A. Therefore, the diameter of a light beam propagating in the first lightguide section 20A and the second lightguide section 30A does not depend on the cross-sectional area of the first lightguide section 20A and the second lightguide section 30A. In other words, the brightness of a virtual image which is obtained by using the lightguide 100a does not depend on the position in a cross section of the first lightguide section 20A and the second lightguide section 30A, whereby the aforementioned unevenness in the brightness of a virtual image can be reduced.

The first lightguide section 20A includes a rod portion which is elongated in the first direction (the Y direction), whereas the second lightguide section 30A includes a planar portion which is parallel to the plane P₁₂ (the XY plane) that contains the first and second directions.

The first light guiding member 1A includes a coupling section 10A having the first light-receiving surface 12A, such that the first light-receiving surface 12A is inclined at predetermined angles with respect to the first, second and third directions. In other words, the normal of the first light-receiving surface 12A is not parallel to any of the first, second and third directions. The coupling section 10A and the first lightguide section 20A may be formed as an integral piece; or, after the coupling section 10A and the first lightguide section 20A are separately produced, the coupling section 10A and the first lightguide section 20A may be allowed to be adhesively bonded to each other. As will be described in detail later, providing the coupling section 10A enhances the efficiency of light utility. Note that the coupling section 10A may be omitted.

Although an example is illustrated herein where the first direction is the Y direction, the second direction is the X direction, and the third direction is the Z direction, it does not matter if the second direction is the −X direction. In other words, the coupling section 10A may be provided on the left-hand side in FIG. 1. Moreover, it does not matter if the first direction is the −Y direction. In other words, the coupling section 10A may be provided on the lower side in FIG. 1.

An operation of the HMD 100A will be described.

Displaying light which has exited the display panel 50 is collimated by the collimating optical system 60, and the collimated light beam strikes the first light-receiving surface 12A of the first light guiding member 1A. The collimating optical system 60 collimates displaying light from each pixel of the display panel 50, and emits a light beam having a predetermined diameter in a direction corresponding to the position of the respective pixel. Let the central direction be defined as the direction in which the displaying light exiting a pixel in the center of the displaying region of the display panel 50 is collimated; then, the direction in which displaying light exiting a pixel at an edge (the upper edge, the lower edge, the left edge, or the right edge) of the displaying region is collimated constitutes a predetermined angle with the central direction. The diameter of a light beam which exits the collimating optical system 60 is adjusted by the collimating optical system 60. As will be described later, the diameter of the light beam can be increased through size adjustment of the coupling section 10A.

As the display panel 50 and the collimating optical system 60, those which are known can be broadly used. For example, a transmission type liquid crystal display panel or an organic EL display panel may be used as the display panel 50, while a lens system which is described in e.g. Japanese Laid-Open Patent Publication No. 2004-157520 may be used as the collimating optical system 60. Alternatively, a reflection type liquid crystal display panel (LCOS) may be used as the display panel 50, while concave mirrors or lenses described in e.g. Japanese Laid-Open Patent Publication No. 2010-282231 may be used as the collimating optical system 60. The entire disclosure of Japanese Laid-Open Patent Publication No. 2004-157520 and Japanese Laid-Open Patent Publication No. 2010-282231 is incorporated herein by reference. The display panel 50 is sized so that it diagonally measures about 0.2 inches to about 0.5 inches, for example.

The first lightguide section 20A of the first light guiding member 1A has, for example, a prism region 22A having formed therein a plurality of first slopes that are inclined in the first direction (the Y direction). The prism region 22A is a region defining a so-called prism surface. Note that a direction in which a slope is inclined means the direction in which the normal of the slope is inclined. Each first slope reflects a light beam propagating through the first lightguide section 20A in the second direction (the X direction), and also expands the light beam in the first direction (the Y direction). Note that arrows heading toward the second lightguide section 30A from the prism region 22A in FIG. 1(a) are shown to schematically illustrate light (three beams of them) exiting the display panel 50 at different positions.

The second light guiding member (second lightguide section) 30A has, for example, a prism region 32A having formed therein a plurality of second slopes that are inclined in the second direction (the X direction). The prism region 32A of the second lightguide section 30A may include, as shown in FIG. 1(b), for example, second slopes 34a which are arranged in a matrix array in a plane that contains the first direction and the second direction (within the XY plane), forming a reflective layer 36a that has openings in a checker pattern. The prism surface of the second lightguide section 30A is exposed in the openings of the reflective layer 36a, thereby allowing a viewer to also see any light which is transmitted through the second lightguide section 30A (see-through type). A semi-reflective layer without openings may instead be formed. Of course, in a non-see-through type application, a reflective layer which lacks openings may be provided.

Each second slope reflects a light beam propagating through the second lightguide section 30A in the third direction (the Z direction), and also expands the light beam in the second direction (the X direction). The viewer (eye) is in the Z direction of the second light guiding member 30A, thus being able to see a virtual image of an image as displayed on the display panel 50 which is created by a light beam that exits the second light guiding member 30A. Herein, the diameter of the light beam entering the eye of the viewer has been expanded in the first direction (the Y direction) and in the second direction (the X direction) by the first lightguide section 20A and the second lightguide section 30A, thus resulting in a broad range in which the virtual image is viewable.

Next, the structure and action of each individual constituent element of the lightguide 100a will be described in detail.

FIGS. 2(a) to (c) are schematic diagrams showing the structure of the lightguide 100a and optical paths of light beams as viewed in a direction which is perpendicular to the XY plane. FIG. 2(a) illustrates optical paths of light beams (broken lines) exiting pixels in the center of the displaying region of the display panel 50; FIG. 2(b) illustrates optical paths of light beams (dot-dash lines) exiting pixels at the lower edge of the displaying region; and FIG. 2(c) illustrates optical paths of light beams (solid lines) exiting pixels at the upper edge of the displaying region. The light beams are light beams which have been collimated by the collimating optical system 60.

As shown in FIG. 2(b), the direction of travel of a light beam resulting through collimation of the light exiting a pixel at the lower edge of the displaying region constitutes an angle+θy with the direction of travel (which may be referred to as a “central direction”, i.e., the direction of travel of the light beams in FIG. 2(a)) of light resulting through collimation of the light exiting a pixel in the center. Moreover, as shown in FIG. 2(c), the direction of travel of a light beam resulting through collimation of the light exiting a pixel at the upper edge of the displaying region constitutes an angle −θy with the central direction.

Light beams entering the first lightguide section 20A, in the course of their propagation inside the first lightguide section 20A, are reflected in the X direction from the plurality of first slopes 24 arrayed along the Y direction in the prism region 22A, thus exiting the first lightguide section 20A through the first outgoing face 29A, which opposes the plane carrying the first slopes 24 (prism surface). At this time, the light beams are expanded in the Y direction. Note that the angle difference between the light beam from each pixel and any light beam from a central pixel (the aforementioned ±θy) is conserved. Note that an optional reflective layer 26 is formed on the prism surface. The reflective layer 26 is made of a metal such as aluminum, for example. Providing the reflective layer 26 allows even a light beam which is incident on the prism surface at an angle smaller than the critical angle to be reflected, thereby enhancing the efficiency of light utility.

Note that air (or a low-refractive index medium: a medium whose refractive index is lower than that of the first lightguide section 20A) exists between the first outgoing face 29A of the first lightguide section 20A and the second light-receiving surface 31A of the second lightguide section 30A, so that a light beam propagating in the first lightguide section 20A undergoes total reflection when incident on the internal plane of the first outgoing face 29A at a critical angle or greater. As a result, the angle difference in a displayed image between light beams along the top-bottom direction (the Y direction) (i.e., the angle of view of the virtual image) is constrained only by the critical angle of the first lightguide section 20A.

Moreover, the first lightguide section 20A can be arranged so that light beams exiting the respective pixels uniformly reach the first slopes 24. For example, as schematically shown in FIGS. 2(a) to (c), by ensuring that the first slopes 24 have an increasing density away from the first light-receiving surface 12A, the intensity distribution of light beams exiting the first outgoing face 29A of the first lightguide section 20A can be made uniform, and the diameter of each light beam can be uniformly expanded in the Y direction.

That is, by using the first light guiding member 1A of the aforementioned structure, the following advantages are additionally obtained.

(1) Without enlarging the first light guiding member 1A, the diameter of any light beam to be collimated by the collimating optical system 60 can be increased, whereby the efficiency of light utility can be improved.

(2) Since the diameter of a light beam to exit the first lightguide section 20A does not depend on the cross-sectional area of the first lightguide section 20A, a first lightguide section 20A with a smaller cross-sectional area can be used than in the case of adopting the construction of

Patent Document 1. In other words, the first light guiding member 1A can be downsized.

(3) Since the angle of view (screen size) of a virtual image is determined by the angle difference between light beams, the angle difference between light beams being determined based on the critical angle of the first lightguide section 20A, the angle of view (screen size) of the virtual image can be increased in the Y direction without having to increase the cross-sectional area of the first lightguide section 20A.

Given an angle difference ±θ_{0(Y)} between light beams along the Y direction (i.e., the angle of view of the virtual image), the following relational expression is derived from the refractive index n and the critical angle θ c of the first lightguide section 20A.

θ_{0(Y)}<sin⁻¹(n·sin((90−θc)/2)),θc=sin⁻¹(1/n)

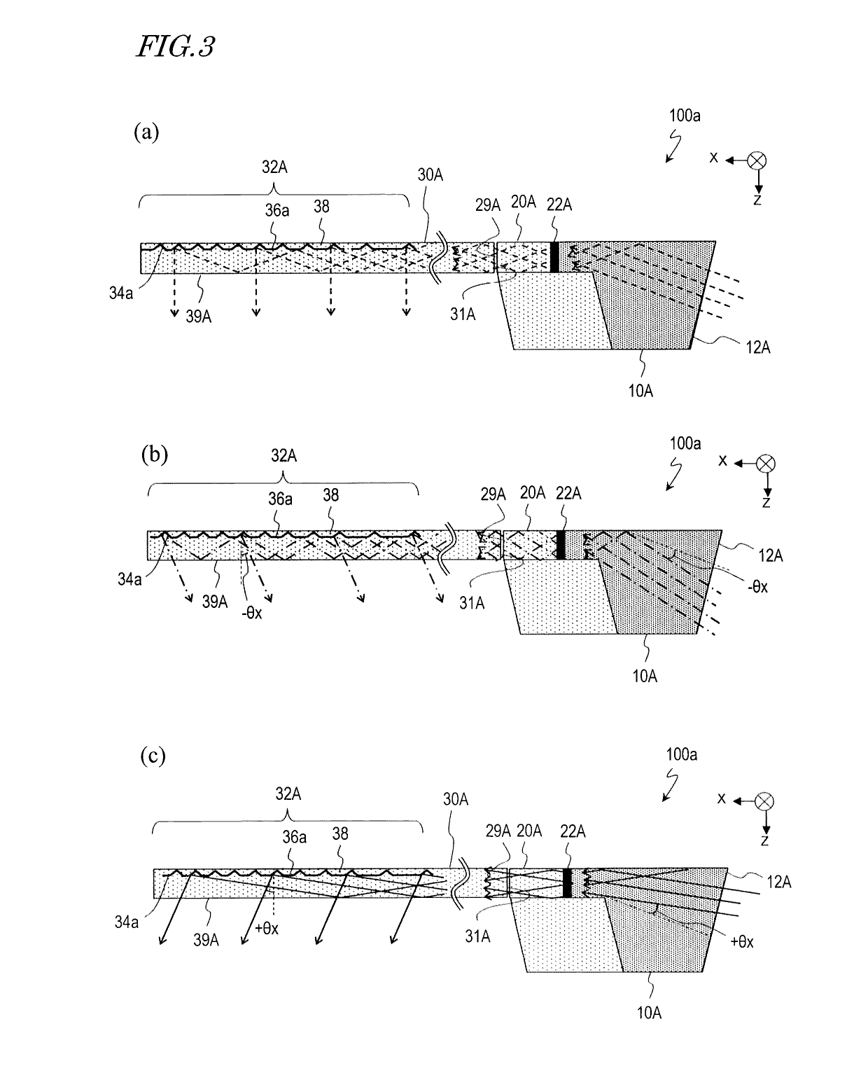

Next, see FIGS. 3(a) to (c). FIGS. 3(a) to (c) are schematic diagrams showing the structure of the lightguide 100a and optical paths of light beams as viewed in a direction which is perpendicular to the XZ plane. FIG. 3(a) illustrates optical paths (broken lines) of light beams exiting pixels in the center of the displaying region of the display panel 50; FIG. 3(b) illustrates optical paths (dot-dash lines) of light beams exiting pixels at the right edge of the displaying region; and FIG. 3(c) illustrates optical paths (solid lines) of light beams exiting pixels at the left edge of the displaying region. The light beams are light beams which have been collimated by the collimating optical system 60.

As shown in FIG. 3(b), the direction of travel of a light beam resulting through collimation of the light exiting a pixel at the right edge of the displaying region constitutes an angle −θx with the central direction (i.e., the direction of travel of the light beams in FIG. 3(a)). Moreover, as shown in FIG. 3(c), the direction of travel of a light beam resulting through collimation of the light exiting a pixel at the left edge of the displaying region constitutes an angle+θx with the central direction.

Light beams entering the first lightguide section 20A, in the course of their propagation inside the first lightguide section 20A, are reflected in the X direction from the plurality of first slopes 24 arrayed along the Y direction in the prism region 22A, thus exiting the first lightguide section 20A through the first outgoing face 29A, which opposes the plane carrying the first slopes 24 (prism surface). At this time, the light beams are expanded in diameter in the Y direction. Note that the angle difference (the aforementioned ±θ x) between the light beam from each pixel and any light beam from a central pixel is conserved.

Light beams exiting the first outgoing face 29A of the first lightguide section 20A strike the second light-receiving surface 31A of the second light guiding member (second lightguide section) 30A. Light beams entering the second lightguide section 30A, in the course of their propagation inside the second lightguide section 30A, are reflected in the Z direction by the plurality of second slopes 34a arrayed along the X direction in the prism region 32A, thus exiting the second lightguide section 30A through the second outgoing face 39A, which opposes the plane carrying the second slopes 34a (prism surface). At this time, the light beams are expanded in the X direction. Note that the angle difference (the aforementioned ±θy and ±θx) between the light beam from each pixel and any light beam from a central pixel is conserved. Note that an optional reflective layer 36a is formed on the prism surface. The reflective layer 36a is made of a metal such as aluminum, for example. Providing the reflective layer 36a allows even a light beam which is incident on the prism surface at an angle smaller than the critical angle to be reflected, thereby enhancing the efficiency of light utility. Furthermore, an optional transparent resin layer 38 is formed on the reflective layer 36a. In the case where the reflective layer 36a has openings, by providing a transparent resin layer 38 having the same or a sufficiently close refractive index to that of the second conductive section 30A, double imaging to be created by the light transmitted through the openings can be suppressed.

The second outgoing face 39A of the second lightguide section 30A is in contact with air (or a low-refractive index medium: a medium whose refractive index is lower than that of the second lightguide section 30A), so that a light beam propagating in the second lightguide section 30A undergoes total reflection when incident on the internal plane of the second outgoing face 39A at a critical angle or greater. As a result, the angle difference in a displayed image between light beams along the right-left direction (the X direction) (i.e., the angle of view of the virtual image) is constrained only by the critical angle of the second lightguide section 30A.

Moreover, the second lightguide section 30A can be arranged so that light beams exiting the respective pixels uniformly reach the second slopes 34a. For example, as schematically shown in FIGS. 3(a) to (c), by ensuring that the second slopes 34a have an increasing density away from the second light-receiving surface 31A, the intensity distribution of light beams exiting the second outgoing face 39A of the second lightguide section 30A can be made uniform, and each light beam can be uniformly expanded in the X direction.

That is, by using the second light guiding member 30A of the aforementioned structure, advantages similar to advantages (1) to (3) above being obtained by using first the light guiding member 1A are attained. However the angle of view of the virtual image in (3) above will be expanded in the X direction.

Given an angle difference ±θ_{0(X)} between light beams along the X direction (i.e., the angle of view of the virtual image), the following relational expression is derived from the refractive index n and the critical angle θ c of the second lightguide section 30A.

θ_{0(X)}<sin⁻¹(n·sin((90−θc)/2)),θc=sin⁻¹(1/n)

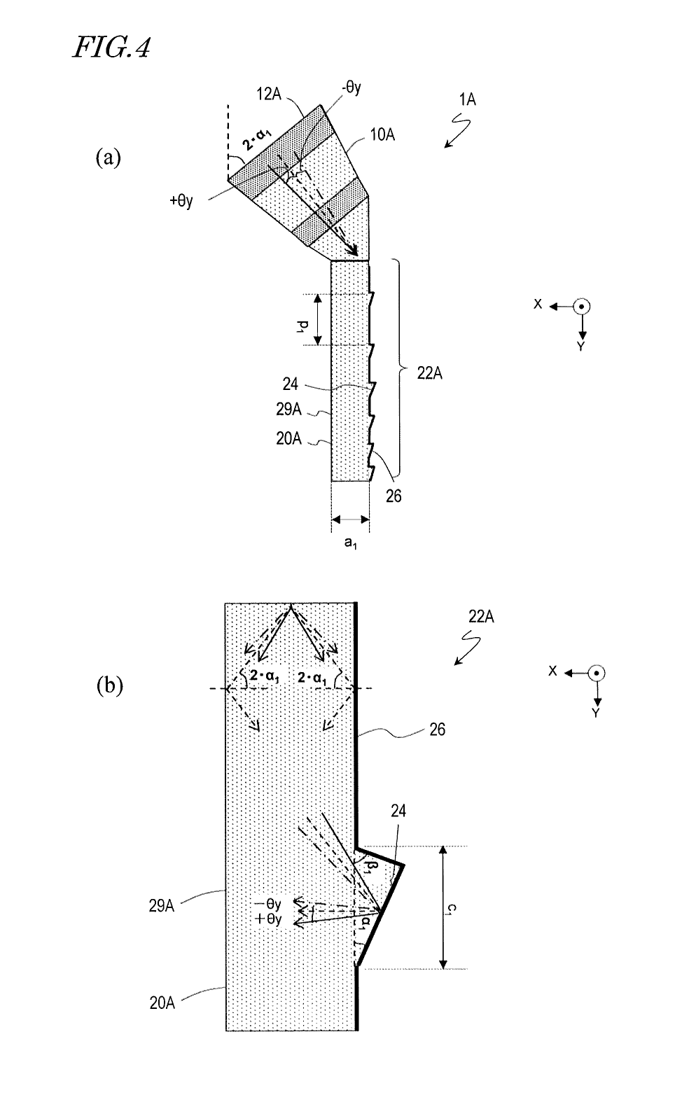

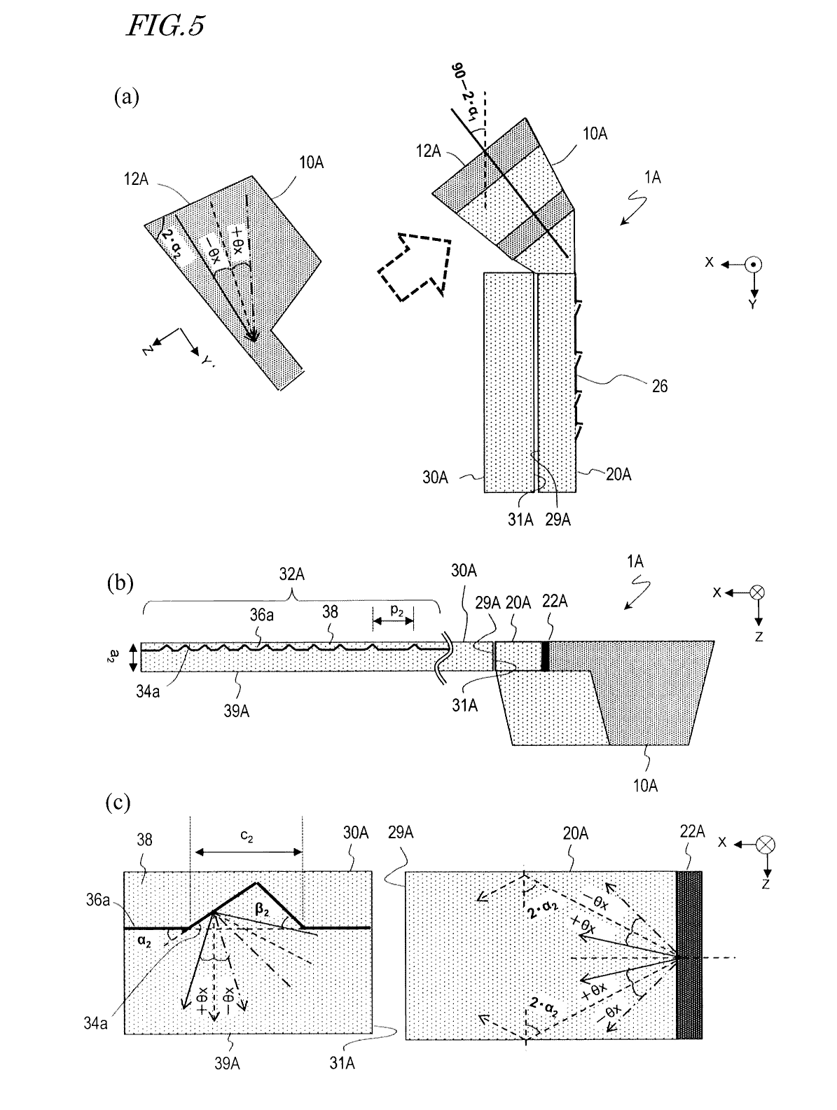

Next, with reference to FIGS. 4(a) and (b) and FIGS. 5(a) to (c), an exemplary structure of the lightguide 100a will be described in detail. FIG. 4(a) is a schematic diagram showing the structure of the first light guiding member 1A and optical paths of light beams as viewed in a direction which is perpendicular to the XY plane; and FIG. 4(b) is a schematic diagram showing optical paths of light beams in the prism region 22A of the first lightguide section 20A. FIG. 5(a) is a schematic diagram showing the structure of the lightguide 100a and incident angles of light beams as viewed in a direction which is perpendicular to the XY plane; FIG. 5(b) is a schematic diagram showing optical paths of light beams in the prism region 32A of the second lightguide section 30A; and FIG. 5(c) is a schematic diagram showing optical paths of light beams in the first lightguide section 20A and the second lightguide section 30A.

First, see FIGS. 4(a) and (b). The first lightguide section 20A includes a rod portion with a rectangular (a₁×b₁) cross section extending along the Y direction, with prisms being arrayed along the Y direction on a plane (prism surface) which is parallel to the YZ plane, these prisms having a length c₁ along the Y direction. Each prism has a first slope 24 to reflect a light beam in the X direction. The first slope 24 is inclined in the Y direction, constituting an angle α₁ (greater than 0° but 45° or less) with the YZ plane.

Each prism has a counterparting slope for the first slope 24 (i.e., a slope constituting an angle β₁ with the YZ plane). However, any light beam striking this slope will cause stray light; therefore, in order to prevent any light beam from striking this slope, β₁ is set so as to satisfy the relationship β₁>2·α₁−θy.

The arraying pitch p₁ of the prisms (first slopes 24) is made smaller away from the first light-receiving surface 12A, so that light beams from the respective pixels will reach the first slopes 24 with a uniform intensity. In addition, or in the alternative, the thickness of the first lightguide section 20A may be made smaller away from the first light-receiving surface 12A. Various light guiding member constructions are known, and any known construction is broadly applicable; however, from the display quality standpoint, it is preferable to use a first lightguide section 20A which includes the first slopes 24 as described above.

As shown in FIG. 4(a), in the XY plane, the first light-receiving surface 12A of the coupling section 10A is disposed so as to constitute an angle of 2·α₁ with the YZ plane. In the meantime, it is ensured that the central direction of the light beam having been collimated through the collimating optical system 60 is substantially perpendicular to the first light-receiving surface 12A. With such an arrangement, in the XY plane, a light beam exiting each pixel and striking the first light-receiving surface 12A constitutes an angle of 2·α₁±θy with the normal (x axis) of the prism surface (which is parallel to the YZ plane) of the first lightguide section 20A, and propagates inside the first lightguide section 20A through repetitive total reflection (total internal reflection)(see FIG. 4(b)). Some of the light beams propagating through the first lightguide section 20A are incident on the first slopes 24, thus being reflected in the X direction so as to exit through the outgoing face (i.e., the plane which opposes the prism surface) of the first lightguide section 20A. At this time, the angle difference between the direction of travel of the light beam exiting each pixel and the center direction is conserved. However, each light beam is expanded in the Y direction in terms of expanse (diameter).

The first light guiding member 1A is produced by through injection molding using a transparent resin, for example. An example of a specific construction is given below.

The angle difference between light beams along the screen top-bottom direction (the Y direction) (i.e., the angle of view of a virtual image):±θ_{0(Y)}=±9 degrees

material: cycloolefin resin, e.g., Zeonor resin manufactured by ZEON CORPORATION (refractive index n≈1.53)
θy=sin⁻¹ (sin(θ₀(y))/n)≈5.89 degrees
θy is a refraction angle of a light beam striking the first light-receiving surface 12A at an incident angle θ₀(y)
α₁=26 degrees
β₁=75 degrees

cross-sectional shape of the first lightguide section 20A: a₁(the X direction)×b₁ (the Z direction)=2.0 mm×1.0 mm

prism width: c₁=0.1 mm

prism pitch: p₁=0.8 mm to 0.15 mm

As necessary, a reflective layer 26 may be formed on the prism surface of the first lightguide section 20A. The reflective layer 26 may be formed through vapor deposition of aluminum, for example. The reflective layer 26 may have a thickness of e.g. several dozen to several hundred nm.

Note that the first lightguide section 20A of the first light guiding member 1A and the coupling section 10A may be formed as an integral piece, or they may be separately produced and attached to each other with an adhesive. At this time, the refractive indices of the first lightguide section 20A, the coupling section 10A, and the adhesive are preferably equal, as much as possible.

Next, see FIGS. 5(a) to (c). The second light guiding member 30A is shaped so as to have a rectangular (a₂×b₂) cross section extending along the x axis direction, with prisms being arrayed along the X direction on a plane (prism surface) which is parallel to the XY plane, these prisms having a length c₂ along the X direction. Each prism has a second slope 34a to reflect a light beam in the Z direction. The second slope 34a is inclined in the X direction, constituting an angle α₂ (greater than 0° but 45° or less) with the XY plane. It also has a counterparting second slope constituting an angle β₂.

Each prism has a counterparting slope for the second slope 34a (i.e., a slope constituting an angle β₂ with the XY plane). However, any light beam striking this slope will cause stray light; therefore, in order to prevent any light beam from striking this slope, β₂ is set so as to satisfy the relationship β₂>2·α₂−θx. If any stray light occurs, it will unfavorably affect the virtual image that is perceived by the viewer (eye).

The arraying pitch p₂ of the prisms (second slopes 34a) is made smaller away from the second light-receiving surface 31A, so that light beams from the respective pixels will reach the second slopes 34a with a uniform intensity. In addition, or in the alternative, the thickness of the second lightguide section 30A may be made smaller away from the second light-receiving surface 31A. Various light guiding member constructions are known, and any known construction is broadly applicable; however, from the display quality standpoint, it is preferable to use a second lightguide section 30A which includes the second slope 34a as described above.

As shown in FIG. 5(a), in a Y′Z plane resulting from rotating the YZ plane by (90−2·α₁) around the Z axis, the first light-receiving surface 12A of the coupling section 10A is disposed so as to constitute an angle of 2·α₂ with the XY plane. In the meantime, it is ensured that the central direction of the light beam having been collimated through the collimating optical system 60 is substantially perpendicularly incident to the first light-receiving surface 12A. With such an arrangement, light beams exiting the respective pixels and striking the first light-receiving surface 12A, in the course of their propagation inside the first lightguide section 20A, are reflected in the X direction by the first slopes 24. At this time, the angle difference between the direction of travel of the light beam exiting each pixel and the center direction is conserved, thus constituting an angle of 2·α₂±θx with the normal (Z axis) of the XY plane of the first lightguide section 20A, as viewed in the XZ plane (see FIG. 5(c)). Similarly, as viewed in the XZ plane, a light beam from each pixel striking the second light guiding member 30A constitutes an angle of 2·α₂±θx with the normal (Z axis) of the XY plane of the second lightguide section 30A, and propagates inside the second lightguide section 30A through repetitive total reflection (total internal reflection). Over this course, it reaches the second slope 34a of the prism mirror, and is reflected in the Z direction to exit the second light guiding member 30A through the second outgoing face 39A. At this time, the angle difference between the direction of travel of the light beam exiting each pixel and the center direction is conserved. However, each light beam is expanded in the X direction in terms of expanse (diameter).

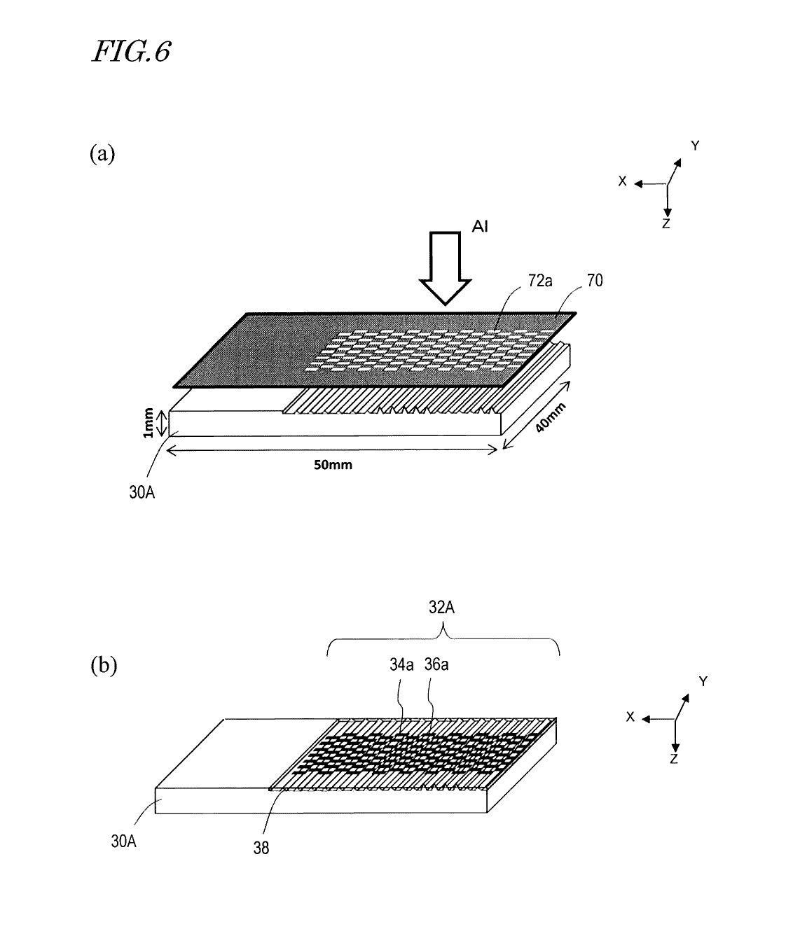

Next, with reference to FIG. 6(a) and FIG. 6(b), an exemplary method of producing a second light guiding member 30A, a reflective layer 36a having openings, and a transparent resin layer 38 will be described.

As shown in FIG. 6(a), through a mask 70 having openings 72a arrayed in a checker pattern, for example, Al (aluminum) is deposited on a second light guiding member 30A that has been provided. In this manner, the reflective layer 36a having openings in a checker pattern as described with reference to FIG. 1(b) is formed. The second slopes 34a are exposed in the openings of the reflective layer 36a. By using the reflective layer 36a having openings, an HMD of a see-through type which allows a virtual image to be viewed as overlaid on a real image (the exterior). Note that, similarly to the first light guiding member 1A, the second light guiding member 30A can be produced by injection molding using a transparent resin, for example.

Next, as shown in FIG. 6(b), a UV-curing resin may be applied on the reflective layer 36a, for example, which may then be irradiated with ultraviolet, thereby forming a transparent resin layer 38 with a planarized surface. By providing a transparent resin layer 38 having the same or a sufficiently close refractive index to that of the second conductive section 30A, double imaging to be created by the light transmitted through the openings can be suppressed. Without being limited to UV-curing resins, thermosetting resins or thermoplastic resins may also be used as the material to compose the transparent resin layer 38.

An example of a specific construction of the second light guiding member 30A is given below.

The angle difference between light beams along the screen right-left direction (the X direction)(i.e., the angle of view of a virtual image):±θ₀x=±16 degrees

material: cycloolefin resin, e.g., Zeonor resin manufactured by ZEON CORPORATION (refractive index n≈1.53)
θx=sin⁻¹(sin(θ₀(x))/n)≈10.38 degrees
   θx is a refraction angle of a light beam striking the first light-receiving surface 12A at an incident angle θ₀(x)
   α₂=34 degrees
   β₂=45 degrees

cross-sectional shape of the second lightguide section 30A: a₂(the Z direction)×b₂ (the Y direction)=1.0 mm×40 mm

prism width: c₂=0.1 mm

prism pitch: p₂=0.8 mm to 0.3 mm

reflective layer 36a: an Al (aluminum) layer with a thickness of several dozen to several hundred nm

transparent resin layer 38: a UV-curing resin with a thickness of several dozen to several hundred μm

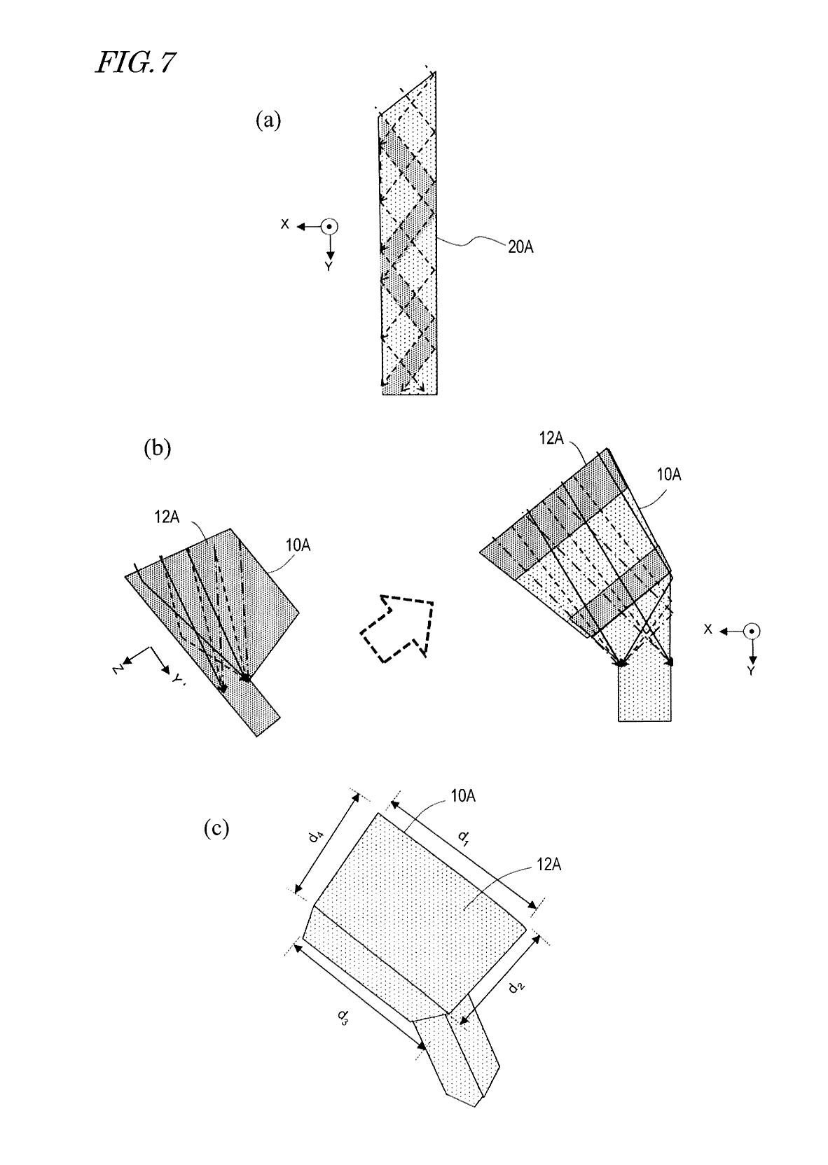

Next, with reference to FIGS. 7(a) to (c), an example of a specific construction of the coupling section 10A will be described below. FIG. 7(a) is a diagram showing optical paths of light beams (central direction) propagating in the first lightguide section 20A in the case where there is no coupling section 10A; FIG. 7(b) is a diagram showing optical paths of light beams (central direction and top-bottom direction) entering the coupling section 10A; and FIG. 7(c) is a diagram describing the shape of the coupling section 10A.

Preferably, the first light-receiving surface 12A not only has a predetermined gradient but also has an adequate size. The reason is that, if the size of the first light-receiving surface 12A is inadequate, then during propagation of light beams inside the first lightguide section 20A and/or the second light guiding member 30A, there will be regions in which light beams cannot exist, consequently creating regions in which outgoing light cannot exist (i.e., the virtual image will become partially lost). In FIG. 7(a), the regions shown darkly hatched represent regions in which light beams cannot exist. The position at which a partial loss of the virtual image will occur depends on the eye position.

By taking into account the difference ±θy along the screen top-bottom direction and the difference ±θx along the screen right-left direction between collimated light beams incident on the first light-receiving surface 12A, the first light-receiving surface 12A may be sized so that these light beams uniformly exist in the first lightguide section 20A and the second lightguide section 30A. The size of the first light-receiving surface 12A can be determined through geometric construction.

In the case of the above-sized first lightguide section 20A and second lightguide section 30A, as shown in FIG. 7(c), a trapezoid as defined by d₁≈6.4 mm, d₂≈3.9 mm, d₃≈5.7 mm, d₄≈3.9 mm may be used. This illustrates an example where, given the cross-sectional size a₁ of the first lightguide section 20A, d₁ and d₃ are prescribed to be twice as large as or greater than a₁ and approximately three times a₁, and given the cross-sectional size a₂ of the second lightguide section 30A, d₂ and d₄ are prescribed to be twice as large as or greater than a₂ and approximately four times a₂. Thus, by ensuring that d₁ and d₃ are twice as large as or greater than a₁ and that d₂ and d₄ are twice as large as or greater than a₂, the aforementioned problems are suppressed, whereby a virtual image without partial losses can be formed.

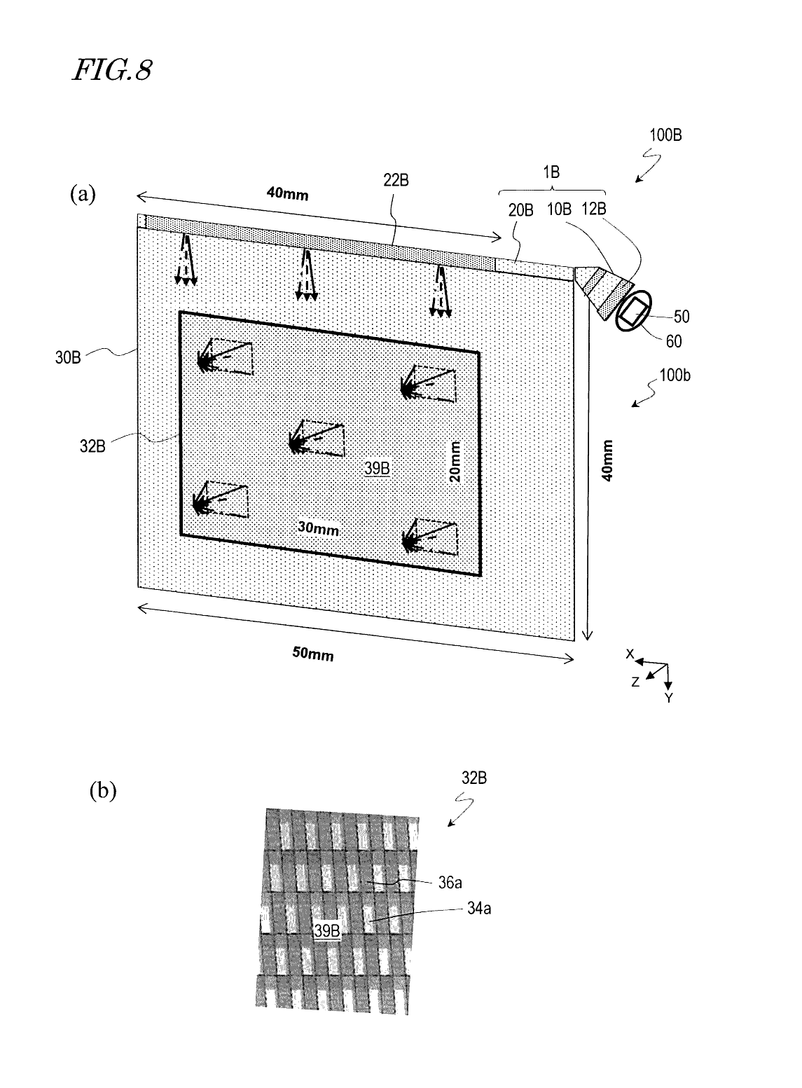

With reference to FIG. 8 to FIG. 16, the structure and function of an HMD 100B according to another embodiment of the present invention will be described. Those constituent elements sharing substantially the same functions with constituent elements of the HMD 100A above will be denoted by the same reference numerals, with their description occasionally being omitted.

FIG. 8(a) is a schematic perspective view of an HMD 100B according to an embodiment of the present invention; and FIG. 8(b) is a schematic enlarged view of a prism region 32B of a second light guiding member (second lightguide section) 30B of a lightguide 100b.

As shown in FIG. 8(a), the HMD 100B includes a lightguide 100b, a display panel 50, and a collimating optical system 60 which collimates displaying light exiting the display panel 50 and emits a collimated light beam. The lightguide 100b is disposed so as to receive the light beam having been collimated through the collimating optical system 60 on a predetermined surface.

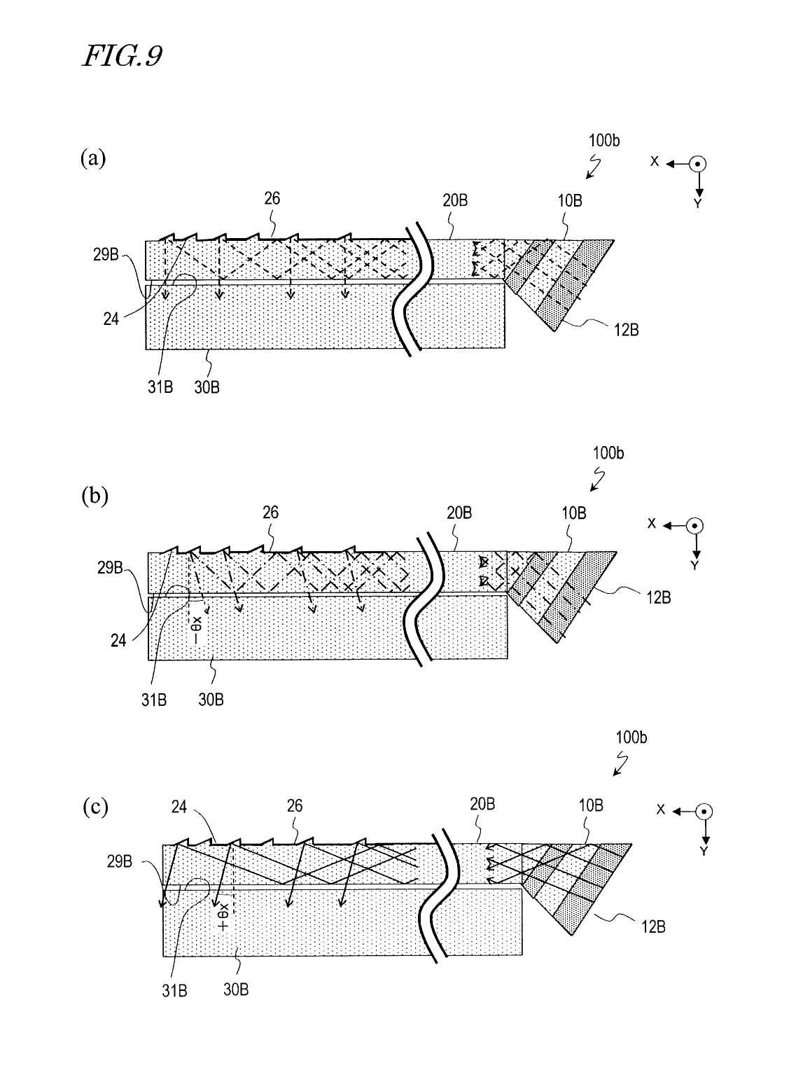

The lightguide 100b includes: a first light guiding member 1B having a first light-receiving surface 12B to receive a collimated light beam, a first lightguide section 20B to allow a light beam entering at the first light-receiving surface 12B to propagate in a first direction (the X direction), and a first outgoing face 29B through which a light beam propagating in the first lightguide section 20B is allowed to exit in a second direction (the Y direction) intersecting the first direction; and a second light guiding member 30B having a second light-receiving surface 31B to receive a light beam exiting from the first outgoing face 29B, a second lightguide section 30B to allow a light beam entering at the second light-receiving surface 31B to propagate in the second direction (the Y direction), and a second outgoing face 39B through which a light beam propagating in the second lightguide section 30B is allowed to exit in a third direction (the Z direction) intersecting the first and second directions. Note that the second lightguide section and the second light guiding member are denoted by the same reference numeral 30B. For the first outgoing face 29B and the second light-receiving surface 31B, see FIGS. 9(a) to (c); for the second outgoing face 39B, see FIG. 8(b).

The lightguide 100b, which includes the first light guiding member 1B and the second light guiding member 30B, is able to reduce unevenness in the brightness of a virtual image to be viewed. A light beam which enters the first lightguide section 20B and the second lightguide section 30B strikes each outgoing face at an angle which is equal to or greater than the critical angle, and through repetitive total reflection, propagates in the first lightguide section 20B and the second lightguide section 30B. Therefore, the diameter of a light beam propagating in the first lightguide section 20B and the second lightguide section 30B does not depend on the cross-sectional area of the first lightguide section 20B and the second lightguide section 30B. In other words, the brightness of a virtual image which is obtained by using the lightguide 100b does not depend on the position in a cross section of the first lightguide section 20B and the second lightguide section 30B, whereby the aforementioned unevenness in the brightness of a virtual image can be reduced.

The first lightguide section 20B includes a rod portion which is elongated in the first direction (the X direction), whereas the second lightguide section 30B includes a planar portion which is parallel to the plane P₁₂ (the XY plane) that contains the first and second directions.

The first light guiding member 1B includes a coupling section 10B having the first light-receiving surface 12B, such that the first light-receiving surface 12B is inclined at predetermined angles with respect to the first, second and third directions. In other words, the normal of the first light-receiving surface 12B is not parallel to any of the first, second and third directions. The coupling section 10B and the first lightguide section 20B may be formed as an integral piece; or, after the coupling section 10B and the first lightguide section 20B are separately produced, the coupling section 10B and the first lightguide section 20B may be allowed to be adhesively bonded to each other. As described earlier, providing the coupling section 10B enhances the efficiency of light utility. Note that the coupling section 10B may be omitted.

Although an example is illustrated herein where the first direction is the X direction, the second direction is the Y direction, and the third direction is the Z direction, it does not matter if the first direction is the −X direction. In other words, the coupling section 10B may be provided on the left-hand side in FIG. 8(a). Moreover, it does not matter if the second direction is the −Y direction. In other words, the coupling section 10B may be provided on the lower side in FIG. 1(a).

The HMD 100B is arranged so that the first light guiding member 1B propagates light beams in the X direction (or the −X direction) and that the second light guiding member 30B propagates light beams in the Y direction (or the −Y direction), thus being distinct from the earlier-described HMD 100A, which is arranged so that the first light guiding member 1A propagates light beams in the Y direction (or the −Y direction) and that the second light guiding member 30A propagates light beams in the X direction (or the −X direction).

An operation of the HMD 100B will be described.

Displaying light which has exited the display panel 50 is collimated by the collimating optical system 60, and the collimated light beam strikes the first light-receiving surface 12B of the first light guiding member 1B. The collimating optical system 60 collimates displaying light from each pixel of the display panel 50, and emits a light beam having a predetermined diameter in a direction corresponding to the position of the respective pixel. Let the central direction be defined as the direction in which the displaying light exiting a pixel in the center of the displaying region of the display panel 50 is collimated; then, the direction in which displaying light exiting a pixel at an edge (the upper edge, the lower edge, the left edge, or the right edge) of the displaying region is collimated constitutes a predetermined angle with the central direction. The diameter of a light beam which exits the collimating optical system 60 is adjusted by the collimating optical system 60. The diameter of the light beam can be increased through size adjustment of the coupling section 10A.

As the display panel 50 and the collimating optical system 60, those which are known can be broadly used, as has been mentioned above with respect to the HMD 100A.

The first lightguide section 20B of the first light guiding member 1B has, for example, a prism region 22B having formed therein a plurality of first slopes that are inclined in the first direction (the X direction). The prism region 22B is a region defining a so-called prism surface. Note that a direction in which a slope is inclined means the direction in which the normal of the slope is inclined. Each first slope reflects a light beam propagating through the first lightguide section 20B in the second direction (the Y direction), and also expands the light beam in the first direction (the X direction). Note that arrows heading toward the second lightguide section 30B from the prism region 32A in FIG. 8(a) are shown to schematically illustrate light (three beams of them) exiting the display panel 50 at different positions.

The second light guiding member (second lightguide section) 30B has, for example, a prism region 32B having formed therein a plurality of second slopes that are inclined in the second direction (the Y direction). The prism region 32A of the second lightguide section 30B may include, as shown in FIG. 8(b), for example, second slopes 34a which are arranged in a matrix array in a plane that contains the first direction and the second direction (within the XY plane), forming a reflective layer 36a that has openings in a checker pattern. The prism surface of the second lightguide section 30B is exposed in the openings of the reflective layer 36a, thereby allowing a viewer to also see any light which is transmitted through the second lightguide section 30B (see-through type). A semi-reflective layer without openings may instead be formed. Of course, in a non-see-through type application, a reflective layer which lacks openings may be provided.

Each second slope reflects a light beam propagating in the second lightguide section 30B in the third direction (the Z direction), and also expands the light beam in the second direction (the Y direction). The viewer (eye) is in the Z direction of the second light guiding member 30B, thus being able to see a virtual image of an image as displayed on the display panel 50 which is created by a light beam that exits the second light guiding member 30B. Herein, the diameter of the light beam entering the eye of the viewer has been expanded in the first direction (the X direction) and in the second direction (the Y direction) by the first lightguide section 20B and the second lightguide section 30B, thus resulting in a broad range in which the virtual image is viewable.

Next, the structure and action of each individual constituent element of the lightguide 100b will be described in detail.

FIGS. 9(a) to (c) are schematic diagrams showing the structure of the lightguide 100b and optical paths of light beams as viewed in a direction which is perpendicular to the XY plane. FIG. 9(a) illustrates optical paths of light beams (broken lines) exiting pixels in the center of the displaying region of the display panel 50; FIG. 9(b) illustrates optical paths of light beams (dot-dash lines) exiting pixels at the right edge of the displaying region; and FIG. 9(c) illustrates optical paths of light beams (solid lines) exiting pixels at the left edge of the displaying region. The light beams are light beams which have been collimated by the collimating optical system 60.

As shown in FIG. 9(b), the direction of travel of a light beam resulting through collimation of the light exiting a pixel at the right edge of the displaying region constitutes an angle −θx with the direction of travel (central direction: the direction of travel of the light beams in FIG. 9(a)) of light resulting through collimation of the light exiting a pixel in the center. Moreover, as shown in FIG. 9(c), the direction of travel of a light beam resulting through collimation of the light exiting a pixel at the right edge of the displaying region constitutes an angle −θx with the central direction.

Light beams entering the first lightguide section 20B, in the course of their propagation inside the first lightguide section 20B, are reflected in the X direction from the plurality of first slopes 24 arrayed along the X direction in the prism region 22B, thus exiting the first lightguide section 20B through the first outgoing face 29B, which opposes the plane carrying the first slopes 24 (prism surface). At this time, the light beams are expanded in the X direction. Note that the angle difference (the aforementioned ±6 x) between the light beam from each pixel and any light beam from a central pixel is conserved. Note that an optional reflective layer 26 is formed on the prism surface. The reflective layer 26 is made of a metal such as aluminum, for example. Providing the reflective layer 26 allows even a light beam which is incident on the prism surface at an angle smaller than the critical angle to be reflected, thereby enhancing the efficiency of light utility.

Note that air (or a low-refractive index medium: a medium whose refractive index is lower than that of the first lightguide section 20B) exists between the first outgoing face 29B of the first lightguide section 20B and the second light-receiving surface 31A of the second lightguide section 30B, so that a light beam propagating in the first lightguide section 20B undergoes total reflection when incident on the internal plane of the first outgoing face 29B at a critical angle or greater. As a result, the angle difference in a displayed image between light beams along the right-left direction (the X direction) (i.e., the angle of view of the virtual image) is constrained only by the critical angle of the first lightguide section 20B.

Moreover, the first lightguide section 20B can be arranged so that light beams exiting the respective pixels uniformly reach the first slopes 24. For example, as shown in schematically shown in FIGS. 9(a) to (c), by ensuring that the first slopes 24 have an increasing density away from the first light-receiving surface 12B, the intensity distribution of light beams exiting the first outgoing face 29B of the first lightguide section 20B can be made uniform, and the diameter of each light beam can be uniformly expanded in the X direction.

That is, by using the first light guiding member 1B of the aforementioned structure, the following advantages are additionally obtained.

(1) Without enlarging the first light guiding member 1B, the diameter of any light beam to be collimated by the collimating optical system 60 can be increased, whereby the efficiency of light utility can be improved.

(2) Since the diameter of a light beam to exit the first lightguide section 20B does not depend on the cross-sectional area of the first lightguide section 20B, a first lightguide section 20B with a smaller cross-sectional area can be used than in the case of adopting the construction of Patent Document 1. In other words, the first light guiding member 1B can be downsized.

(3) Since the angle of view (screen size) of a virtual image is determined by the angle difference between light beams, the angle difference between light beams being determined based on the critical angle of the first lightguide section 20B, the angle of view (screen size) of the virtual image can be increased in the X direction without having to increase the cross-sectional area of the first lightguide section 20B.

Given an angle difference ±θ_{0(X)} between light beams along the X direction (i.e., the angle of view of the virtual image), the following relational expression is derived from the refractive index n and the critical angle θ c of the first lightguide section 20B.

θ_{0(X)}<sin⁻¹ (n·sin((90−θc)/2)), θc=sin⁻¹(1/n)

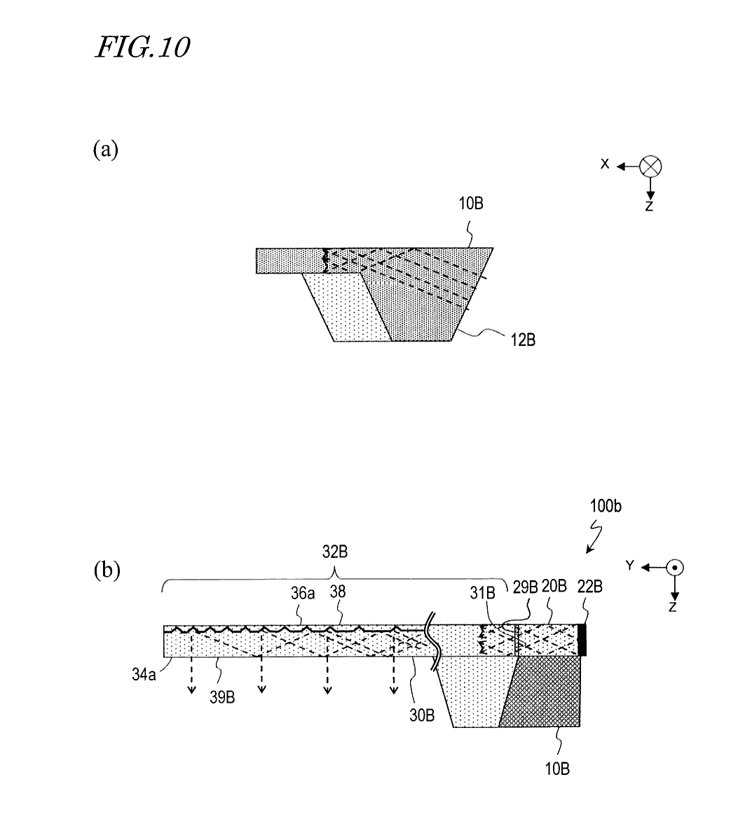

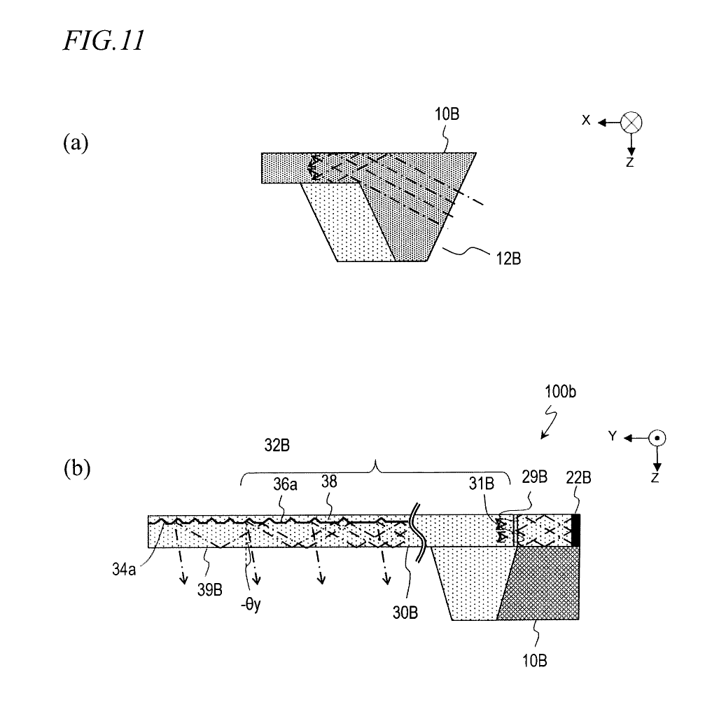

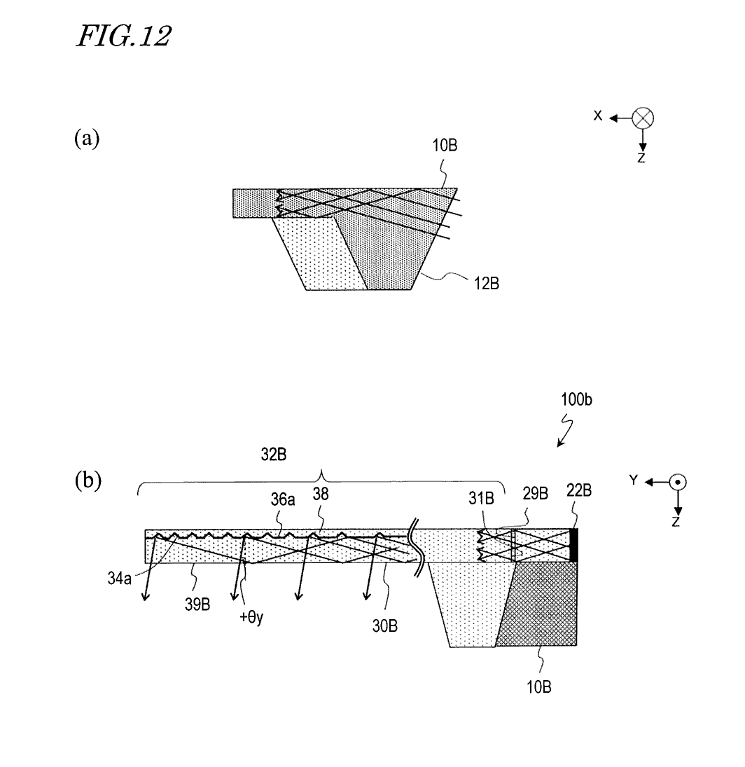

Next, see FIG. 10 to FIG. 12. FIG. 10(a) is a schematic diagram showing the structure of the coupling section 10B and optical paths of light beams as viewed in a direction which is perpendicular to the XZ plane; and FIG. 10(b) is a schematic diagram showing the structure of the lightguide 100a and optical paths of light beams as viewed in a direction which is perpendicular to the YZ plane, illustrating optical paths (broken lines) of light beams exiting pixels in the center of the displaying region of the display panel 50. FIG. 11(a) is a schematic diagram showing the structure of the coupling section 10B and optical paths of light beams as viewed in a direction which is perpendicular to the XZ plane; and FIG. 11(b) is a schematic diagram showing the structure of the lightguide 100b and optical paths of light beams as viewed in a direction which is perpendicular to the YZ plane, illustrating optical paths of light beams (dot-dash lines) exiting pixels at the lower edge of the displaying region of the display panel 50. FIG. 12(a) is a schematic diagram showing the structure of the coupling section 10B and optical paths of light beams as viewed in a direction which is perpendicular to the XZ plane; FIG. 12(b) is a schematic diagram showing the structure of the lightguide 100b and optical paths of light beams as viewed in a direction which is perpendicular to the YZ plane, illustrating optical paths of light beams (solid lines) exiting pixels at the upper edge of the displaying region of the display panel 50.

As shown in FIGS. 11(a) and (b), the direction of travel of a light beam resulting through collimation of the light exiting a pixel at the lower edge of the displaying region constitutes an angle −θy with the central direction (i.e., the direction of travel of light beams in FIG. 10(a), (b)) Moreover, as shown in FIGS. 12(a) and (b), the direction of travel of a light beam resulting through collimation of the light exiting a pixel at the upper edge of the displaying region constitutes an angle +θy with the central direction.

Light beams entering the first lightguide section 20B, in the course of their propagation inside the first lightguide section 20B, are reflected in the Y direction by the plurality of first slopes 24 arrayed along the X direction in the prism region 22B, thus exiting the first lightguide section 20B through the first outgoing face 29B, which opposes the plane carrying the first slopes 24 (prism surface). At this time, the light beams are expanded in diameter in the X direction. Note that the angle difference between the light beam from each pixel and any light beam from a central pixel (the aforementioned ±θy) is conserved.

Light beams exiting the first outgoing face 29B of the first lightguide section 20B strike the second light-receiving surface 31B of the second light guiding member (second lightguide section) 30B. Light beams entering the second lightguide section 30B, in the course of their propagation inside the second lightguide section 30B, are reflected in the Z direction by the plurality of second slopes 34a arrayed along the Y direction in the prism region 32B, thus exiting the second lightguide section 30B through the second outgoing face 39B, which opposes the plane carrying the second slopes 34a (prism surface). At this time, the light beams are expanded in the Y direction. Note that the angle difference (the aforementioned ±θx and ±θy) between the light beam from each pixel and any light beam from a central pixel is conserved. Note that an optional reflective layer 36a is formed on the prism surface. The reflective layer 36a is made of a metal such as aluminum, for example. Providing the reflective layer 36a allows even a light beam which is incident on the prism surface at an angle smaller than the critical angle to be reflected, thereby enhancing the efficiency of light utility. Furthermore, an optional transparent resin layer 38 is formed on the reflective layer 36a. In the case where the reflective layer 36a has openings, by providing a transparent resin layer 38 having the same or a sufficiently close refractive index to that of the second conductive section 30A, double imaging to be created by the light transmitted through the openings can be suppressed.

The second outgoing face 39B of the second lightguide section 30B is in contact with air (or a low-refractive index medium: a medium whose refractive index is lower than that of the second lightguide section 30B), so that a light beam propagating in the second lightguide section 30B undergoes total reflection when incident on the internal plane of the second outgoing face 39B at a critical angle or greater. As a result, the angle difference in a displayed image between light beams along the top-bottom direction (the Y direction) (i.e., the angle of view of the virtual image) is constrained only by the critical angle of the second lightguide section 30B.

Moreover, the second lightguide section 30B can be arranged so that light beams exiting the respective pixels uniformly reach the second slopes 34a. For example, as schematically shown in FIG. 10 to FIG. 12, by ensuring that the second slopes 34a have an increasing density away from the second light-receiving surface 31B, the intensity distribution of light beams exiting the second outgoing face 39B of the second lightguide section 30B can be made uniform, and each light beam can be uniformly expanded in the Y direction.

That is, by using the second light guiding member 30B of the above structure, advantages similar to advantages (1) to (3) above being obtained by using the first light guiding member 1B are attained. However, the angle of view of the virtual image in (3) above will be expanded in the Y direction.

Given an angle difference ±θ_{0(Y)} between light beams along the Y direction (i.e., the angle of view of the virtual image), the following relational expression is derived from the refractive index n and the critical angle θ c of the second lightguide section 30B.

θ_{0(Y)}<sin⁻¹(n·sin((90−θc)/2)),θc=sin⁻¹(1/n)

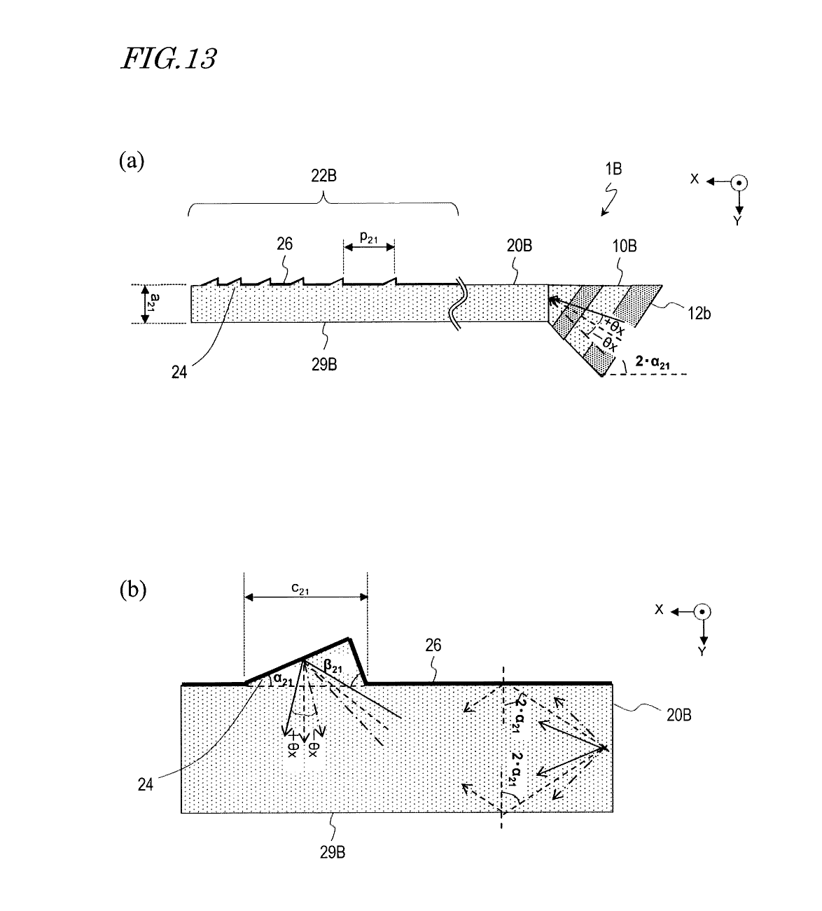

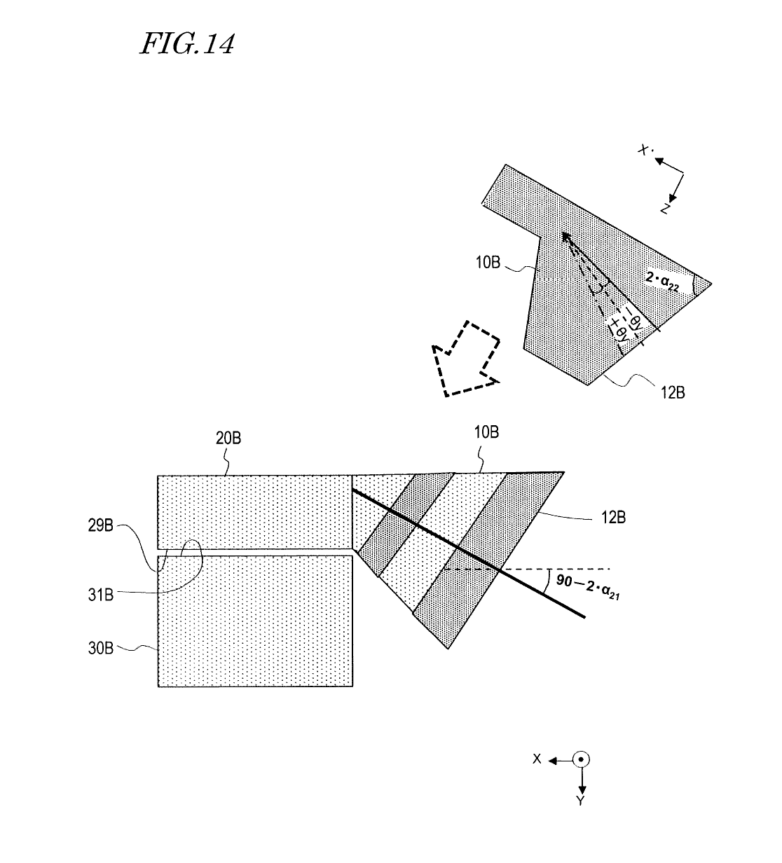

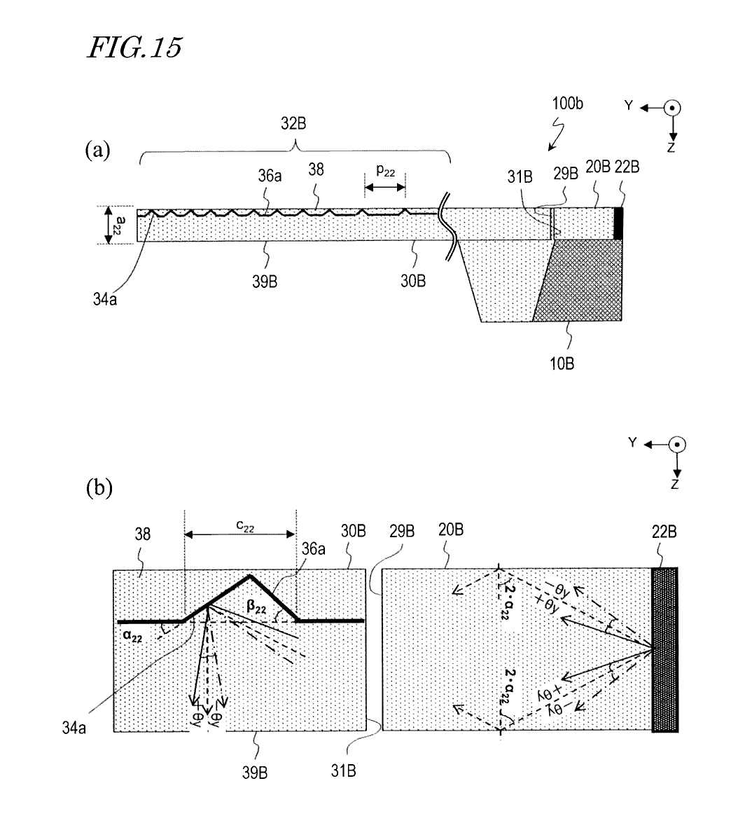

Next, with reference to FIG. 13 to FIG. 15, an exemplary structure of the lightguide 100a will be described in detail. FIG. 13(a) is a schematic diagram showing the structure of the first light guiding member 1B and optical paths of light beams as viewed in a direction which is perpendicular to the XY plane; and FIG. 13(b) is a schematic diagram showing optical paths of light beams in the prism region 22B of the first lightguide section 20B. FIG. 14 is a schematic diagram showing the structure of the lightguide 100b and optical paths of light beams as viewed in a direction which is perpendicular to the XY plane. FIG. 15(a) is a schematic diagram showing the structure of the lightguide 100b as viewed in a direction which is perpendicular to the YZ plane; and FIG. 15(b) is a schematic diagram showing optical paths of light beams in the first lightguide section 20B and the second lightguide section 30B.

First, see FIGS. 13(a) and (b). The first lightguide section 20B includes a rod portion with a rectangular (a₂₁×b₂₁) cross section extending along the X direction, with prisms being arrayed along the X direction on a plane (prism surface) which is parallel to the XZ plane, these prisms having a length c₂₁ along the X direction. Each prism has a first slope 24 to reflect a light beam in the Y direction. The first slope 24 is inclined in the X direction, constituting an angle α₂₁ (greater than 0° but 45° or less) with the XZ plane.

Each prism has a counterparting slope for the first slope 24 (i.e., a slope constituting an angle 1321 with the XZ plane). However, any light beam striking this slope will cause stray light; therefore, in order to prevent any light beam from striking this slope, β₂₁ is set so as to satisfy the relationship β₂₁>2·α₂₁−θx.

The arraying pitch p₂₁ of the prisms (first slopes 24) is made smaller away from the first light-receiving surface 12B, so that light beams from the respective pixels will reach the first slopes 24 with a uniform intensity. In addition, or in the alternative, the thickness of the first lightguide section 20B may be made smaller away from the first light-receiving surface 12B. Various light guiding member constructions are known, and any known construction is broadly applicable; however, from the display quality standpoint, it is preferable to use a first lightguide section 20B which includes the first slopes 24 as described above.

As shown in FIG. 13(a), in the XY plane, the first light-receiving surface 12B of the coupling section 10B is disposed so as to constitute an angle of 2·α₂₁ with the XZ plane. In the meantime, it is ensured that the central direction of the light beam having been collimated through the collimating optical system 60 is substantially perpendicular to the first light-receiving surface 12B. With such an arrangement, in the XY plane, a light beam exiting each pixel and striking the first light-receiving surface 12B constitutes an angle of 2·α₂₁±θx with the normal (Y axis) of the prism surface (which is parallel to the XZ plane) of the first lightguide section 20B, and propagates inside the first lightguide section 20B through repetitive total reflection (total internal reflection) (see FIG. 13(b)). Some of the light beams propagating through the first lightguide section 20B are incident on the first slopes 24, thus being reflected in the X direction so as to exit through the outgoing face (i.e., the plane which opposes the prism surface) of the first lightguide section 20B. At this time, the angle difference between the direction of travel of the light beam exiting each pixel and the center direction is conserved. However, each light beam is expanded in the X direction in terms of expanse (diameter).

The first light guiding member 1B is produced by through injection molding using a transparent resin, for example. An example of a specific construction is given below.

The angle difference between light beams along the screen right-left direction (the X direction) (i.e., the angle of view of a virtual image):±00(x)=±16 degrees

material: cycloolefin resin, e.g., Zeonor resin manufactured by ZEON CORPORATION (refractive index n≈1.53)
θx=sin⁻¹(sin(θ₀(x))/n)≈10.38 degrees
θx is a refraction angle of a light beam striking the first light-receiving surface 12B at an incident angle θ₀(x)
α₂₁=28 degrees
β₂₁=75 degrees

cross-sectional shape of the first lightguide section 20B: a₂₁ (the Y direction)×b₂₁(the Z direction)=2.0 mm×1.0 mm

prism width: c₂₁=0.1 mm

prism pitch: p₂₁=0.8 mm to 0.15 mm

As necessary, a reflective layer 26 may be formed on the prism surface of the first lightguide section 20B.

The reflective layer 26 may be formed through vapor deposition of aluminum, for example. The reflective layer 26 may have a thickness of e.g. several dozen to several hundred nm.

Note that the first lightguide section 20B of the first light guiding member 1B and the coupling section 10B may be formed as an integral piece, or they may be separately produced and attached to each other with an adhesive. At this time, the refractive indices of the first lightguide section 20B, the coupling section 10B, and the adhesive are preferably equal, as much as possible.

Next, see FIG. 14 and FIGS. 15(a), (b).

The second light guiding member 30A is shaped so as to have a rectangular (a₂×b₂) cross section extending along the x axis direction, with prisms being arrayed along the X direction on a plane (prism surface) which is parallel to the XY plane, these prisms having a length c₂ along the X direction. Each prism has a second slope 34a to reflect a light beam in the Z direction. The second slope 34a is inclined in the X direction, constituting an angle α₂₂ (greater than 0° but 45° or less) with the XY plane. It also has a counterparting second slope constituting an angle β₂₂.

Each prism has a counterparting slope for the second slope 34a (i.e., a slope constituting an angle β₂₂ with the XY plane). However, any light beam striking this slope will cause stray light; therefore, in order to prevent any light beam from striking this slope, β₂₂ is set so as to satisfy the relationship β₂₂>2·α₂₂−θx. If any stray light occurs, it will unfavorably affect the virtual image that is perceived by the viewer (eye).

The arraying pitch p₂ of the prisms (second slopes 34a) is made smaller away from the second light-receiving surface 31B, so that light beams from the respective pixels will reach the second slopes 34a with a uniform intensity. In addition, or in the alternative, the thickness of the second lightguide section 30A may be made smaller away from the second light-receiving surface 31B. Various light guiding member constructions are known, and any known construction is broadly applicable; however, from the display quality standpoint, it is preferable to use a second lightguide section 30A which includes the second slopes 34a as described above.

As shown in FIG. 14, in an X′Z plane resulting from rotating the XZ plane by (90−2·α₂₂) around the Z axis, the first light-receiving surface 12B of the coupling section 10B is disposed so as to constitute an angle of 2·α₂₂ with the XY plane. In the meantime, it is ensured that the central direction of the light beam having been collimated through the collimating optical system 60 is substantially perpendicularly incident to the first light-receiving surface 12B. With such an arrangement, light beams exiting the respective pixels and striking the first light-receiving surface 12B, in the course of their propagation inside the first lightguide section 20B, are reflected in the Y direction by the first slopes 24. At this time, the angle difference between the direction of travel of the light beam exiting each pixel and the center direction is conserved, thus constituting an angle of 2·α₂₂±θy with the normal (Z axis) of the XY plane of the first lightguide section 20B, as viewed in the YZ plane (see FIG. 15(b)). Similarly, as viewed in the YZ plane, a light beam from each pixel striking the second light guiding member 30B constitutes an angle of 2·α₂₂±θy with the normal (Z axis) of the XY plane of the second lightguide section 30B, and propagates inside the second lightguide section 30B through repetitive total reflection (total internal reflection). Over this course, it reaches the second slope 34a of the prism mirror, and is reflected in the Z direction to exit the second light guiding member 30B through the second outgoing face 39B. At this time, the angle difference between the direction of travel of the light beam exiting each pixel and the center direction is conserved. However, each light beam is expanded in the Y direction in terms of expanse (diameter).

An example of a specific construction of the second light guiding member 30B is given below.

The angle difference between light beams along the screen top-bottom direction (the Y direction)(i.e., the angle of view of a virtual image):±θ₀(y)=±9 degrees

material: cycloolefin resin, e.g., Zeonor resin manufactured by ZEON CORPORATION (refractive index n≈1.53)
θy=sin⁻¹(sin(θ₀(y))/n)≈5.89 degrees
   θy is a refraction angle of a light beam striking the first light-receiving surface 12B at an incident angle θ₀(y)
   α₂₂=33 degrees
   β₂₂=45 degrees

cross-sectional shape of the second lightguide section 30A: a₂ₛ(the Z direction)×b₂₂ (the X direction)=1.0 mm×50 mm

prism width: c₂₂=0.1 mm

prism pitch: p₂₂=0.8 mm to 0.3 mm

reflective layer 36a: an Al (aluminum) layer with a thickness of several dozen to several hundred nm

transparent resin layer 38: a UV-curing resin with a thickness of several dozen to several hundred μm

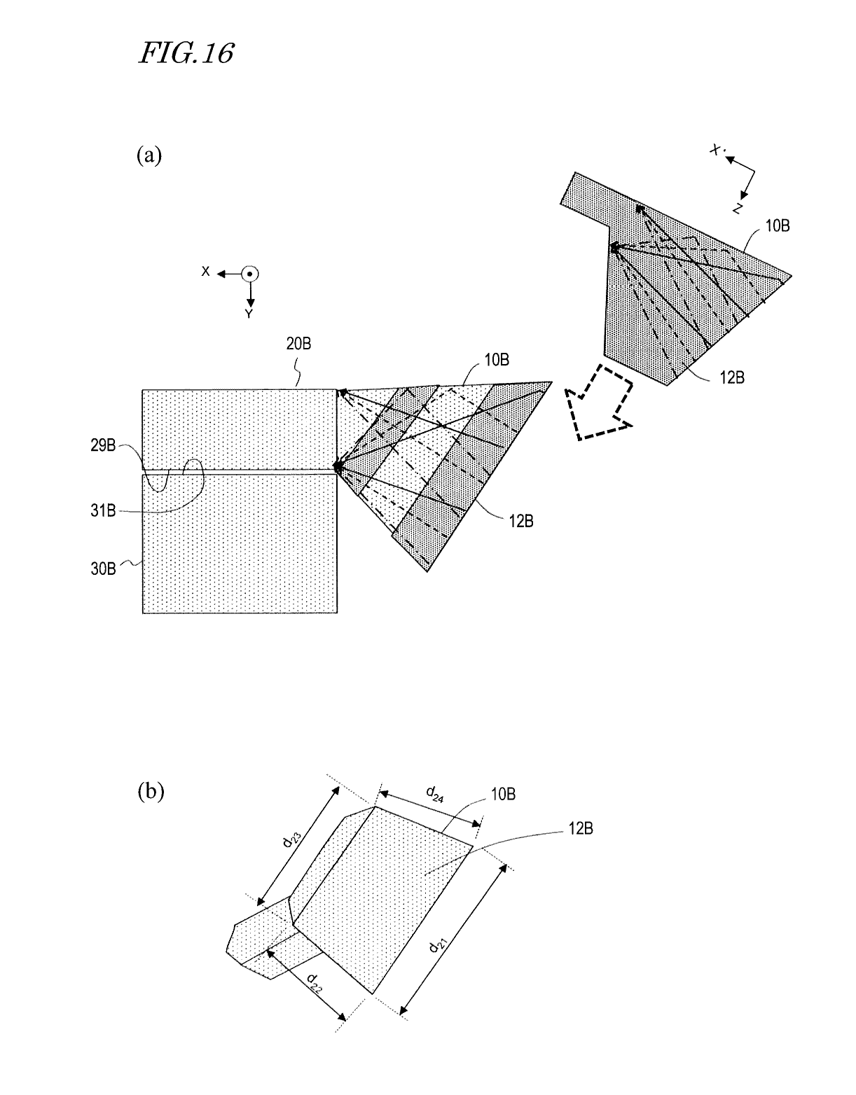

Next, with reference to FIGS. 16(a) and (b), example of a specific construction of the coupling section 10B will be described below. FIG. 16(a) is a diagram showing optical paths of light beams (central direction and right-left direction) entering the coupling section 10B; and FIG. 16(b) is a diagram showing optical paths of light beams (central direction and top-bottom direction) entering the coupling section 10A.

Preferably, the first light-receiving surface 12B not only has a predetermined gradient but also has an adequate size. As has been described with reference to FIG. 7(a), if the size of the first light-receiving surface 12B is inadequate, then during propagation of light beams inside the first lightguide section 20B and/or the second light guiding member 30B, there will be regions in which light beams cannot exist, consequently creating regions in which outgoing light cannot exist (i.e., the virtual image will become partially lost)

By taking into account the difference ±θy along the screen top-bottom direction and the difference ±θx along the screen right-left direction between collimated light beams incident on the first light-receiving surface 12B, the first light-receiving surface 12B may be sized so that these light beams uniformly exist in the first lightguide section 20B and the second lightguide section 30B. The size of the first light-receiving surface 12B can be determined through geometric construction.

In the case of the above-sized first lightguide section 20B and second lightguide section 30B, as shown in FIG. 16(b), a trapezoid as defined by d₂₁≈5.6 mm, d₂₂≈3.4 mm, d₂₃≈4.4 mm, d₂₄≈3.4 mm may be used. This illustrates an example where, given the cross-sectional size a₂₁ of the first lightguide section 20B, d₂₁ and d₂₃ are prescribed to be twice as large as or greater than a₂₁ and approximately three times a₂₁, and given the cross-sectional size a₂₂ of the second lightguide section 30B, d₂₂ and d₂₄ are prescribed to be twice as large as or greater than a₂₂ and approximately four times a₂₂. Thus, by ensuring that d₂₁ and d₂₃ are twice as large as or greater than a₂₁ and that d₂₂ and d₂₄ are twice as large as or greater than a₂₂, the aforementioned problems are suppressed, whereby a virtual image without partial losses can be formed.

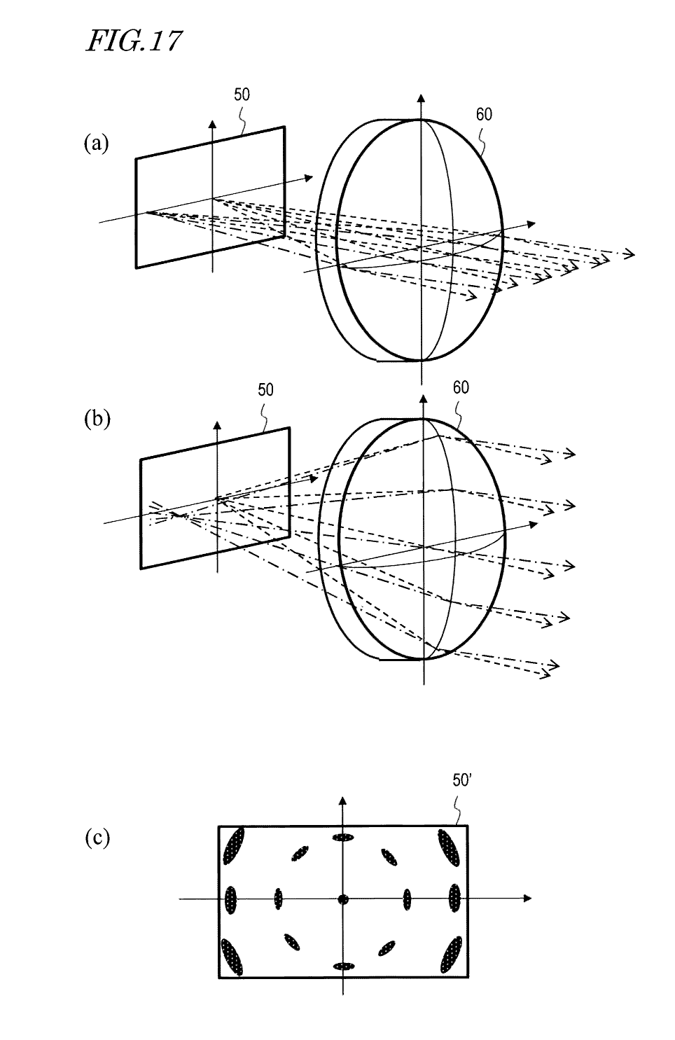

Next, see FIGS. 17(a) to (c). FIGS. 17(a) and (b) are diagrams for describing aberration associated with the collimating optical system 60. FIG. 17(a) shows aberration along the right-left direction; FIG. 17(b) shows aberration along the top-bottom direction; and FIG. 17(c) is a diagram showing how a virtual image 50′ may be blurred.

Generally speaking, the collimating optical system 60 has aberration, such that displaying light exiting the screen center of the display panel 50, which is disposed on the optical axis of the collimating optical system 60, becomes a light beam with a relatively good precision (i.e., having a high degree of parallelism) through collimation, but the degree of parallelism of the light beam will become lower away from the screen center. Stated otherwise, displaying light exiting pixels adjoining the predetermined pixel will stray into the collimated light beam. Therefore, the lowered degree of parallelism of the light beam exhibits itself as a blur of the virtual image that is finally viewed (as indicated by the blur in a virtual image 50′ in FIG. 17(c)).

Moreover, the display panel 50 is often longer from side to side than from top to bottom (having an aspect ratio of 4:3 or 16:9, etc.), and thus the degree of parallelism tends to be low at the upper and lower edges of the center of the displaying region and even lower at the right and left edges of the center, with the lowest degree of parallelism existing in the four corners of the displaying region.

FIGS. 17(a) to (c) illustrate an example of how aberration may commonly occur in the collimating optical system 60. This example depicts a case where, at greater distances from the screen center on the optical axis, more displaying light from pixels adjoining in any concentric circular direction strays into parallel light from the predetermined pixel, while relatively little displaying light strays in from any pixels adjoining in a direction perpendicular to the concentric circle. Herein, displaying light from the adjoining pixels, straying into the parallel light from the predetermined pixel, passes through the outer periphery of the collimating optical system 60.

Therefore, when the collimating optical system 60 has such aberration, light exiting the upper and lower regions of the collimating optical system 60 causes substantial blurs at the screen corners and right and left edges of the virtual image. Conversely, blurs in the virtual image can be reduced by preventing the light exiting the upper and lower regions of the collimating optical system 60 from entering the first lightguide section 20A.

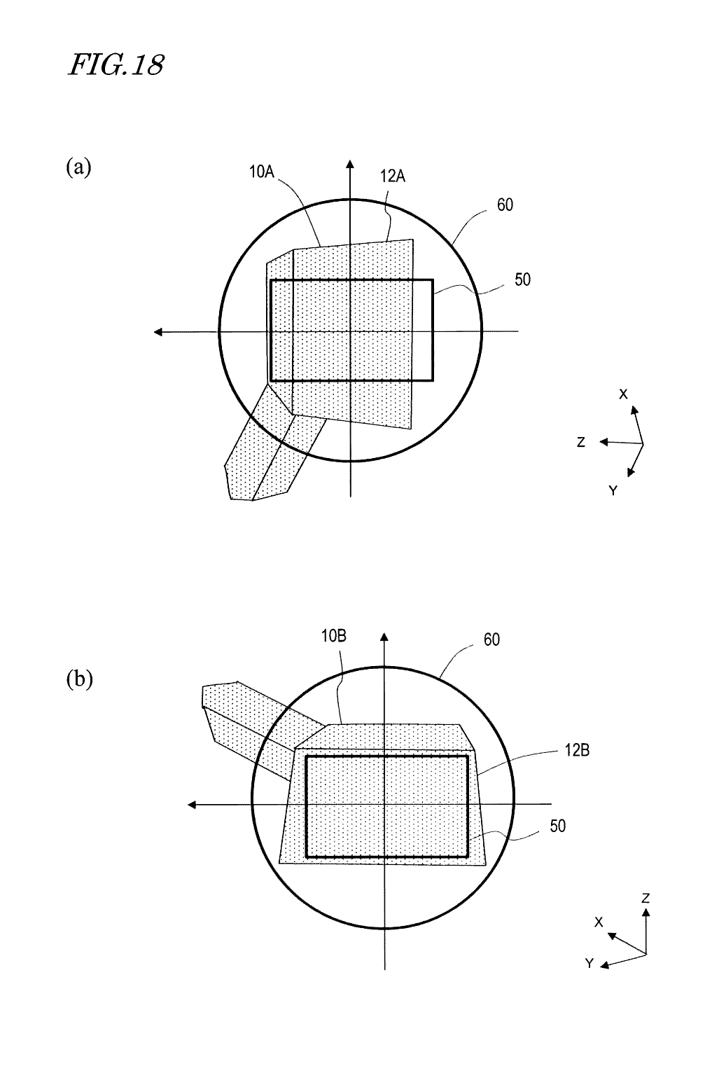

With reference to FIGS. 18(a) and (b), relative positioning of the display panel 50 and the collimating optical system 60 and a first light-receiving surface 12A or 12B will be described.

In the HMD 100A, as shown in FIG. 18(a), the first light-receiving surface 12A of the coupling section 10A is shorter along the right-left direction and longer along the top-bottom direction of the display panel 50. Therefore, substantial blurs are likely to occur at the screen corners and right and left edges of the virtual image, because of the light exiting the upper and lower regions of the collimating optical system 60.

On the other hand, in the HMD 100B, as shown in FIG. 18(b), the first light-receiving surface 12B of the coupling section 10B is longer along the right-left direction and shorter along the top-bottom direction of the display panel 50. Therefore, blurs at the screen corners and right and left edges of the virtual image can be suppressed, free from the influence of light exiting the upper and lower regions of the collimating optical system 60.

Thus, in the case of a collimating optical system having aberration as illustrated in FIG. 17, it is preferable to dispose the first light-receiving surface 12B as in the HMD 100B.

Since the aberration of the collimating optical system 60 may be of various characteristics, either construction of the HMD 100A or the HMD 100B may be appropriately selected in accordance with such characteristics.

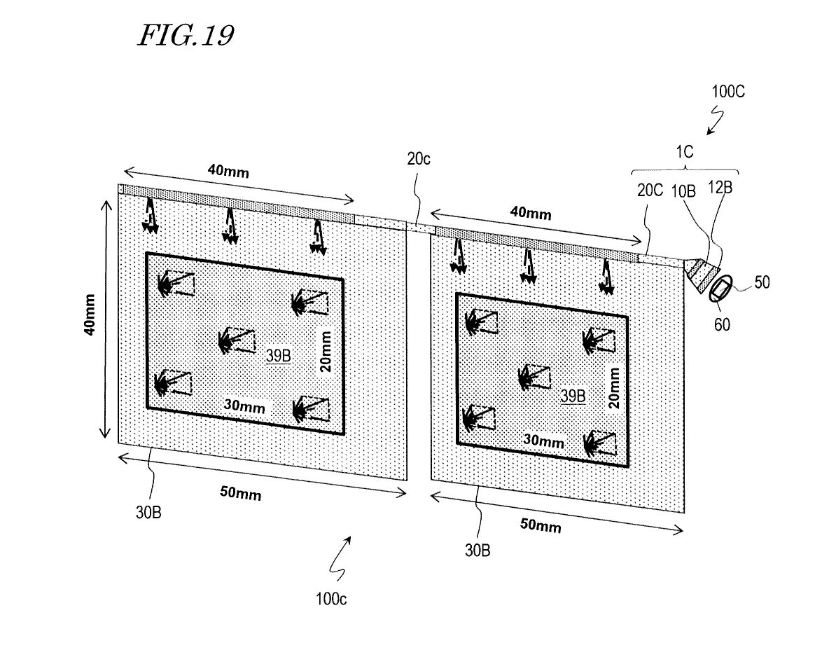

FIG. 19 shows a schematic perspective view of an HMD 100C according to another embodiment of the present invention. While the HMDs 100A and 100B above are of constructions that allow a virtual image to be viewed with a single eye (one of the eyes), the HMD 100C has a construction that allows a virtual image to be viewed with both eyes.

The HMD 100C includes, for a single first light guiding member 1C, two second light guiding members 30B that are arrayed in parallel along the first direction (the X direction). The first light guiding member 1C has a similar construction to that of the first light guiding member 1B, but differs from the first light guiding member 1B in that it includes a connecting lightguide section 20c, which connects the two first lightguide sections 20B. The distance between the two first lightguide sections 20B (i.e., the length of the connecting lightguide section 20c) may be adjusted in accordance with the interval between both eyes. Such a construction allows the number of parts to be decreased over the case where either an HMD 100A or an HMD 100B is provided for each eye. It will be appreciated that, as the first light guiding member 1C, an integral piece may be used into which the two first lightguide sections 20B and the connecting lightguide section 20c are made.

The present specification discloses lightguides and head-mounted displays as described in the following Items.

### [Item 1]

A lightguide comprising:

a first light guiding member having a first light-receiving surface to receive a collimated light beam, a first lightguide section to allow the light beam entering at the first light-receiving surface to propagate in a first direction, and a first outgoing face through which the light beam propagating in the first lightguide section is allowed to exit in a second direction intersecting the first direction; and

a second light guiding member having a second light-receiving surface to receive the light beam exiting from the first outgoing face, a second lightguide section to allow the light beam entering at the second light-receiving surface to propagate in the second direction, and a second outgoing face through which the light beam propagating in the second lightguide section is allowed to exit in a third direction intersecting the first and second directions.

The lightguide of Item 1 is able to reduce unevenness in the brightness of a virtual image to be viewed.

### [Item 2]

The lightguide of Item 1, wherein,

the first light guiding member includes a coupling section having the first light-receiving surface; and

the first light-receiving surface is inclined at predetermined angles with respect to the first, second and third directions.

The lightguide of Item 2 is able to effectively enhance the efficiency of light utility.

### [Item 3]

The lightguide of Item 1 or 2, wherein,

the first light guiding member has a plurality of first slopes inclined in the first direction; and

the plurality of first slopes allow the light beam propagating in the first lightguide section to be reflected in the second direction, and expands the light beam in the first direction.

With the lightguide of Item 3, the range in which a virtual image is viewable (viewing angle) is expanded in the first direction.

### [Item 4]

The lightguide of Item 3, wherein,

the second light guiding member has a plurality of second slopes inclined in the second direction; and

the plurality of second slopes allow the light beam propagating in the second lightguide section to be reflected in the third direction, and expands the light beam in the second direction.

With the lightguide of Item 4, the range in which a virtual image is viewable (viewing angle) is expanded also in the second direction.

### [Item 5]

The lightguide of Item 4, wherein the plurality of first slopes constitute an angle α₁ with a plane P₁₃ containing the first and third directions, and the plurality of second slopes constitute an angle α₂ with a plane P₁₂ containing the first and second directions, the angle α₁ and the angle α₂ each independently being 45° or less.

With the lightguide of Item 5, a virtual image with a high display quality can be obtained.

### [Item 6]

The lightguide of Item 5, wherein the first light-receiving surface constitutes, in the plane P₁₂, an angle of 2·α₁ with the plane P₂₃, and in a plane P′₂₃ resulting from rotating the plane P₂₃ by (90−2·α₁) degrees around the third direction, an angle of 2·α₂ with the plane P₁₂.

With the lightguide of Item 6, a light beam can be efficiently led to the first lightguide section.

### [Item 7]

The lightguide of Item 5 or 6, wherein the first light-receiving surface has a side whose length is equal to or greater than twice the length along the second direction of a cross section of the first lightguide section which is parallel to the plane P₂₃, and a side whose length is equal to or greater than twice the length along the third direction of a cross section of the first lightguide section which is parallel to the plane P₁₃.

With the lightguide of Item 7, a virtual image without partial losses can be formed.

### [Item 8]

The lightguide of any of Items 1 to 7, wherein the first lightguide section includes a rod portion which is elongated in the first direction, and the second lightguide section includes a planar portion which is parallel to a plane containing the first and second directions.

The lightguide of Item 8 has a shape which is suitably used for an HMD.

### [Item 9]

The lightguide of any of Items 1 to 8 comprising one said first light guiding member and two said second light guiding members arrayed in parallel along the first direction.

The lightguide of Item 9 is to be used in an HMD which allows a virtual image to be viewed with both eyes.

### [Item 10]

A head-mounted display comprising: a display panel;

a collimating optical system to collimate displaying light exiting the display panel and emit a collimated light beam; and

the lightguide of any of Items 1 to 9,

the lightguide being disposed so that the first light-receiving surface receives the light beam having been collimated through the collimating optical system.

The HMD of Item 10 allows a virtual image with reduced unevenness in brightness to be viewed.

### INDUSTRIAL APPLICABILITY

A lightguide according to the present invention is applicable to an HMD, an HUD or any other virtual image display or the like.

### REFERENCE SIGNS LIST

1A first light guiding member
12A first light-receiving surface
20A first lightguide section
29A first outgoing face
30A second lightguide section (second light guiding member)
31A second light-receiving surface
39A second outgoing face
100a lightguide
100A HMD

1. A lightguide comprising:
a first light guiding member having a first light-receiving surface to receive a collimated light beam, a first lightguide section to allow the light beam entering at the first light-receiving surface to propagate in a first direction, and a first outgoing face through which the light beam propagating in the first lightguide section is allowed to exit in a second direction intersecting the first direction; and
a second light guiding member having a second light-receiving surface to receive the light beam exiting from the first outgoing face, a second lightguide section to allow the light beam entering at the second light-receiving surface to propagate in the second direction, and a second outgoing face through which the light beam propagating in the second lightguide section is allowed to exit in a third direction intersecting the first and second directions.

2. The lightguide of claim 1, wherein,
the first light guiding member includes a coupling section having the first light-receiving surface; and
the first light-receiving surface is inclined at predetermined angles with respect to the first, second and third directions.

3. The lightguide of claim 1, wherein,
the first light guiding member has a plurality of first slopes inclined in the first direction; and
the plurality of first slopes allow the light beam propagating in the first lightguide section to be reflected in the second direction, and expands the light beam in the first direction.

4. The lightguide of claim 3, wherein,
the second light guiding member has a plurality of second slopes inclined in the second direction; and
the plurality of second slopes allow the light beam propagating in the second lightguide section to be reflected in the third direction, and expands the light beam in the second direction.

5. The lightguide of claim 4, wherein the plurality of first slopes constitute an angle α₁ with a plane P₁₃ containing the first and third directions, and the plurality of second slopes constitute an angle α₂ with a plane P₁₂ containing the first and second directions, the angle α₁ and the angle α₂ each independently being 45° or less.

6. The lightguide of claim 5, wherein the first light-receiving surface constitutes, in the plane P₁₂, an angle of 2·α₁ with the plane P₁₃, and in a plane P′₁₃ resulting from rotating the plane P₁₃ by (90−2·α₁) degrees around the third direction, an angle of 2·α₂ with the plane P₁₂.

7. The lightguide of claim 5, wherein the first light-receiving surface has a side whose length is equal to or greater than twice the length along the second direction of a cross section of the first lightguide section which is parallel to the plane P₂₃, and a side whose length is equal to or greater than twice the length along the third direction of a cross section of the first lightguide section which is parallel to the plane P₁₃.

8. The lightguide of claim 1, wherein the first lightguide section includes a rod portion which is elongated in the first direction, and the second lightguide section includes a planar portion which is parallel to a plane containing the first and second directions.

9. The lightguide of claim 1 comprising one said first light guiding member and two said second light guiding members arrayed in parallel along the first direction.

10. A head-mounted display comprising:
a display panel;
a collimating optical system to collimate displaying light exiting the display panel and emit a collimated light beam; and
the lightguide of claim 1,
the lightguide being disposed so that the first light-receiving surface receives the light beam having been collimated through the collimating optical system.
